(19) United States
(12) Patent Application Publication
(10) Pub. No.: US 2018/0013305 A1
(43) Pub. Date: Jan. 11, 2018

(54) POWER MANAGEMENT APPARATUS, POWER MANAGEMENT SYSTEM, AND POWER MANAGEMENT METHOD

(71) Applicant: FUJITSU LIMITED, Kawasaki-shi (JP)

(72) Inventor: Masaharu KAKO, Toukai (JP)

(73) Assignee: FUJITSU LIMITED, Kawasaki-shi (JP)

(21) Appl. No.: 15/584,646

(22) Filed: May 2, 2017

(30) Foreign Application Priority Data
Jul. 5, 2016 (JP) 2016-133611

(51) Int. Cl. H02J 7/00; G05B 15/02

(52) U.S. Cl. CPC H02J 7/0068; G05B 15/02; H02J 7/007

(57) ABSTRACT

A power management apparatus configured to control charge and discharge of the battery, power discharged from the battery being supplied to a power consumption apparatus, the power management apparatus includes a memory, and a processor coupled to the memory and configured to receive, from the power consumption apparatus, first information indicating a first power amount which is predicted to be used in the power consumption apparatus, determine, based on the first power amount, a first value that is a value regarding a residual amount of the battery and is used for determining which of the charge and the discharge of the battery is to be preferentially executed, and control, based on the determined first value and the residual amount of the battery, the charge and the discharge of the battery.

### CROSS-REFERENCE TO RELATED APPLICATION

This application is based upon and claims the benefit of priority of the prior Japanese Patent Application No. 2016-133611, filed on Jul. 5, 2016, the entire contents of which are incorporated herein by reference.

### FIELD

The embodiments discussed herein are related to a power management apparatus, a power management system, and a power management method.

### BACKGROUND

In recent years, a household or a company is installed with a solar power generation apparatus and sells a surplus among power of obtained by solar power generation. A household or a company is installed with a solar power generation apparatus together with a storage battery and, for example, stores a surplus of power generated in daytime in the storage battery and uses power of the storage battery in night-time or at a power failure to thereby cut the peak of received power from a commercial power supply.

As a relevant technology, a technology for predicting a power generation amount of a solar battery and a demanded power amount and making a charge and discharge plan to thereby cut the peak of the power from a commercial power supply in an electric power system including the solar battery and a storage battery is suggested. Also, a technology for predicting the maximum peak value of a storage battery capacity and controlling the storage battery to thereby reduce generation of a reverse flow and cut the peak of the power from an external power supply system is suggested. As prior art documents, there are Japanese Laid-Open Patent Publication No. 2009-284586 and Japanese Laid-Open Patent Publication No. 2012-120419.

### SUMMARY

According to an aspect of the invention, a power management apparatus configured to control charge and discharge of the battery, power discharged from the battery being supplied to a power consumption apparatus, the power management apparatus includes a memory, and a processor coupled to the memory and configured to receive, from the power consumption apparatus, first information indicating a first power amount which is predicted to be used in the power consumption apparatus, determine, based on the first power amount, a first value that is a value regarding a residual amount of the battery and is used for determining which of the charge and the discharge of the battery is to be preferentially executed, and control, based on the determined first value and the residual amount of the battery, the charge and the discharge of the battery.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the entire configuration of a system of an embodiment;

FIG. 2 is a state transition diagram illustrating power control by a power control apparatus;

FIG. 3 is a diagram illustrating an example of a summary of operations of a system of Embodiment 1;

FIGS. 4A and 4B are flowcharts illustrating an example of a flow of a process (at the time of first reception) of a power management apparatus of Embodiment 1 when a power utilization request is received;

FIG. 5 is a diagram illustrating an example of a power reservation value table;

FIG. 6 is a diagram illustrating an example of a power utilization request message;

FIG. 7 is a diagram illustrating an example of a power utilization response message;

FIG. 8 is a diagram illustrating an example of a utilization power ticket list;

FIGS. 9A and 9B are (first) flowcharts illustrating an example of a flow of a process (at the time of continuous reception) of the power management apparatus of Embodiment 1 when the power utilization request is received;

FIG. 10 is a (second) flowchart illustrating an example of the flow of the process (at the time of continuous reception) of the power management apparatus of Embodiment 1 when the power utilization request is received;

FIGS. 11A and 11B are flowcharts illustrating an example of a process in a case where a power consumption apparatus receives a power utilization response message;

FIG. 12 is a flowchart illustrating an example of a power utilization-continuation request process by the power consumption apparatus;

FIG. 13 is a flowchart illustrating a process of the power consumption apparatus when power utilization is ended;

FIG. 14 is a flowchart illustrating an example of a process when the power management apparatus of Embodiment 1 receives a power utilization end notification from the power consumption apparatus;

FIG. 15 is a (first) flowchart illustrating a process periodically performed by the power management apparatus and the power control apparatus of Embodiment 1;

FIG. 16 is a (second) flowchart illustrating the process periodically performed by the power management apparatus and the power control apparatus of Embodiment 1;

FIG. 17 is a flowchart illustrating a process of the power control apparatus, the power consumption apparatus, and the power management apparatus at a power failure and at a recovery from power failure;

FIG. 18 is a graph illustrating an example of power consumption including power consumption without guarantee against power failure (utilization reservation power amount of storage battery);

FIG. 19 is a diagram illustrating an example of a summary of operations of a system of Embodiment 2;

FIGS. 20A and 20B are flowcharts illustrating an example of a flow of a process (at the time of first reception) of a power management apparatus of Embodiment 2 when a power utilization request is received;

FIGS. 21A and 21B are (first) flowcharts illustrating an example of a flow of a process (at the time of continuous reception) of the power management apparatus of Embodiment 2 when the power utilization request is received;

FIG. 22 is a (second) flowchart illustrating an example of the flow of the process (at the time of continuous reception) of the power management apparatus of Embodiment 2 when the power utilization request is received;

FIGS. 23A and 23B are flowcharts illustrating an example of a process when the power management apparatus of Embodiment 2 receives a power utilization end notification from the power consumption apparatus;

FIG. 24 is a (first) flowchart illustrating a process periodically performed by the power management apparatus and the power control apparatus of Embodiment 2;

FIG. 25 is a (second) flowchart illustrating the process periodically performed by the power management apparatus and the power control apparatus of Embodiment 2; and

FIG. 26 is a diagram illustrating an example of a hardware configuration of the power management apparatus and the power control apparatus.

### DESCRIPTION OF EMBODIMENTS

In a case where charge and discharge are performed based on a power amount of a storage battery, for example, in a state where the power amount of the storage battery is greater than or equal to a predetermined reference value, selling of power or supplying of power to the power consumption apparatus is performed. In this state, in a case where a demand for power is increased, a discharge capacity is increased such that a residual amount of the storage battery may become less than or equal to a reference value at an early stage and may have to be recharged. The lifetime of the storage battery becomes shorter as the number of switching times of charge and discharge of the storage battery is increased, which is problematic.

### Embodiment 1

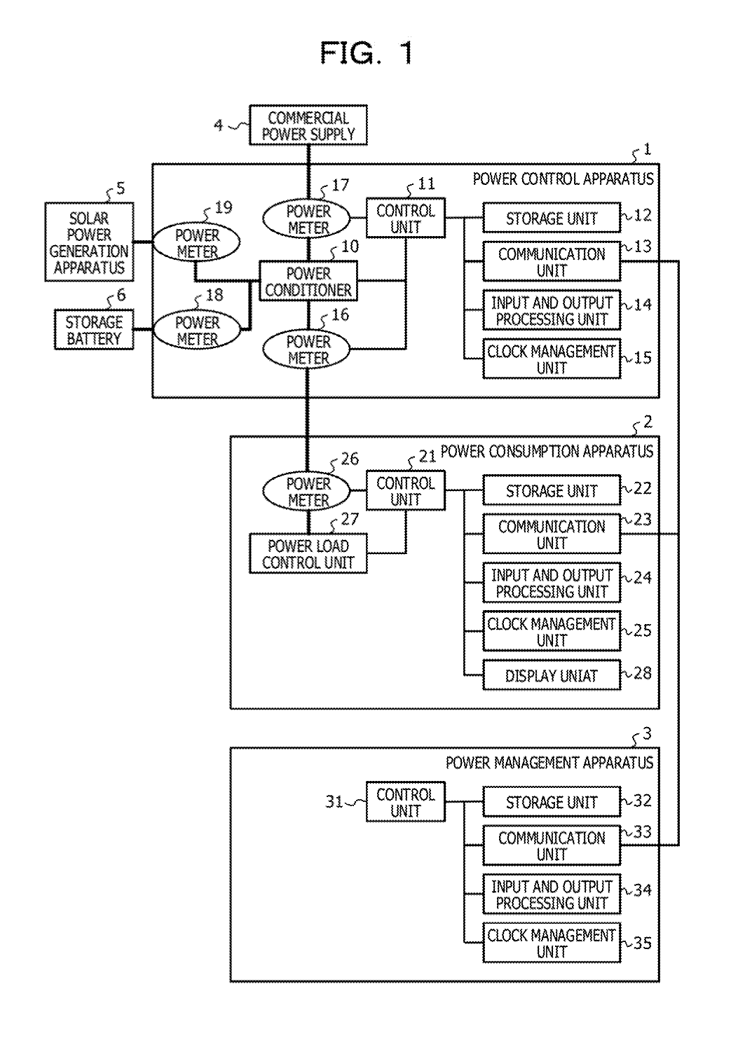

In the following, Embodiment 1 will be described with reference to the accompanying drawings. FIG. 1 is a diagram illustrating an example of the entire configuration of a power management system of the embodiment. The power management system includes a power control apparatus 1, a power consumption apparatus 2, a power management apparatus 3, a commercial power supply 4, a solar power generation apparatus 5, and a storage battery 6. In the example illustrated in FIG. 1, the number of the power consumption apparatus 2 is one, but the power management system may include a plurality of power consumption apparatuses 2 (power consumption apparatus 2₁, 2₂ . . . ). In the following, in a case where description is made without distinguishing the plurality of the power consumption apparatuses 2₁, 2₂ . . . , it may be described as the power consumption apparatus 2.

The power control apparatus 1 includes a power conditioner 10, a control unit 11, a storage unit 12, a communication unit 13, an input and output processing unit 14, a dock management unit 15, a power meter 16, a power meter 17, a power meter 18, and a power meter 19.

The control unit 11 receives power from the solar power generation apparatus 5 and performs control of power-purchase and power-selling with respect to the commercial power supply 4 and control of charge and discharge (In the following, may be described to as charge-discharge) with respect to the storage battery 6. The control unit 11 preferentially performs at least one of control of power-purchase from the commercial power supply 4 and control of charge of storage battery 6, for example, when a residual amount of the storage battery 6 becomes less than a first threshold value (storing power reference value #1). The control unit 11 preferentially performs at least one of control of power-selling of the commercial power supply 4 and control of discharge of the storage battery 6, for example, when the residual amount of the storage battery 6 exceeds a second threshold value (storing power reference value #2) which is greater than the first threshold value. The control unit 11 updates the second threshold value based on a reference value (storing power reference value #2) acquired from the power management apparatus 3.

The control unit 11 instructs a control content to the power conditioner 10 to thereby realize control described above.

Otherwise, the power conditioner 10 may include the control unit 11.

The storage unit 12 stores various pieces of information demanded for power control, for example, Information indicating power acquired from the power meters 16 to 19 and information acquired from the power consumption apparatus 2 and the power management apparatus 3. The communication unit 13 performs transmission and reception of information with the power consumption apparatus 2 and the power management apparatus 3. The input and output processing unit 14 performs input and output control of various pieces of Information. The dock management unit 15 performs time management.

The power meter 16 measures power consumption of the power consumption apparatus 2. In a case where there is a plurality of power consumption apparatuses 2, the power meter 16 measures total power consumption of the plurality of the power consumption apparatuses 2. The power meter 17 measures power for selling and power for purchasing with respect to the commercial power supply 4. The power meter 18 measures charged power and discharges power with respect to the storage battery 6. The power meter 19 measures power received from the solar power generation apparatus 5.

The power consumption apparatus 2 includes a control unit 21, a storage unit 22, a communication unit 23, an input and output processing unit 24, a dock management unit 25, a power meter 26, a power load control unit 27, and a display unit 28.

The control unit 21 performs various control regarding operations of the power consumption apparatus 2. The control unit 21 edits a power utilization request message and a power utilization end notification message that are transmitted to the power management apparatus 3 based on, for example, power consumption acquired from the power meter 26, a power utilization response message acquired from the power management apparatus 3, and operation contents from a user.

The storage unit 22 stores various pieces of information regarding operations of the power consumption apparatus 2. The storage unit 22 stores, for example, the power consumption acquired from the power meter 26, contents indicated by the power utilization response message acquired from the power management apparatus 3, and operation contents from a user. The communication unit 23 performs transmission and reception of information with the power control apparatus 1 and the power management apparatus 3. The input and output processing unit 24 performs input and output control of various pieces of information. The clock management unit 25 performs time management. The power meter 26 measures power consumption in the power consumption apparatus 2. The power load control unit 27 controls a load which consumes power. The display unit 28 displays information regarding operations, such as operations at a power failure, of the power consumption apparatus 2.

The power management apparatus 3 includes a control unit 31, a storage unit 32, a communication unit 33, an input and output processing unit 34, and a dock management unit 35.

The control unit 31 makes a utilization reservation for at least one of the commercial power supply 4 and the storage battery 6 based on utilization reservation information (for example, information indicated in the power utilization request message) transmitted from the power consumption apparatus 2. The control unit 31 determines (calculates) a reference value with respect to a residual amount of the storage battery 6 for determining which of charge and discharge of the storage battery 6 is to be preferentially performed by the power control apparatus 1, based on a utilization reservation situation.

The storage unit 32 stores various pieces of information regarding power management. The storage unit 32 stores, for example, a utilization power ticket list indicating a utilization reservation situation of the power consumption apparatus 2. The communication unit 33 performs transmission and reception of information with the power control apparatus 1 and the power consumption apparatus 2. That is, the power management apparatus 3 has the communication unit 33 and accordingly, is communicable with the power control apparatus 1 and the power consumption apparatus 2. The input and output processing unit 34 performs input and output control of various pieces of information. The clock management unit 35 performs time management.

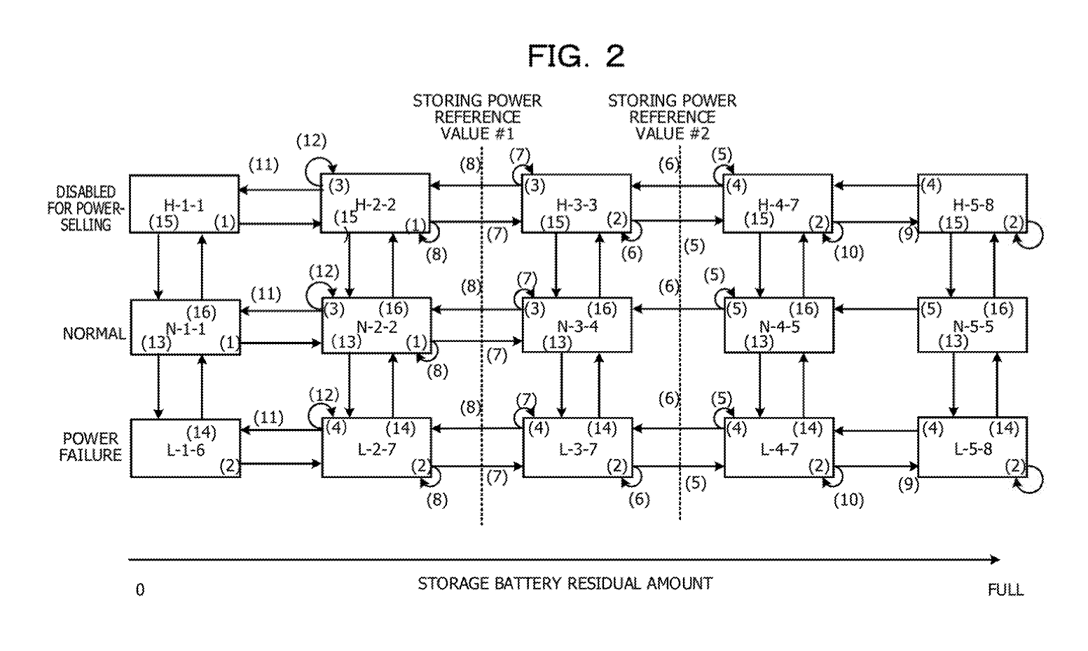

FIG. 2 is a state transition diagram illustrating power control by the power control apparatus. Description will be made on states indicated by X, Y, and Z when respective states are denoted by X-Y-Z.

The X indicates a state of the commercial power supply 4 and respective values H, N, and L indicate the following states. H: disabled for power-selling (voltage of commercial power supply 4 is greater than or equal to a specified value), N: normal, and L: power failure (voltage of commercial power supply 4 is within the specified value). Y indicates a storing power level of the storage battery 6 and respective values of 1 to 5 indicate the following states. 1: depletion, 2: between depletion and storing power reference value #1, 3: between storing power reference value #1 and storing power reference value #2, 4: between storing power reference value #2 and full, 5: full

The Z indicates a power control state and values of 1 to 8 indicate the following states. 1: The power control apparatus 1 purchases power to the contracted maximum power value from the commercial power supply 4 and charges the storage battery 6 with the surplus power in a case where (in a case where summed power is greater than power consumption) summed power of power from the solar power generation apparatus 5 and power from the commercial power supply 4 is a surplus. 2: The power control apparatus 1 purchases power to the contracted maximum power value from the commercial power supply 4. In a case where the summed power of power from the solar power generation apparatus 5 and power from the commercial power supply 4 is a surplus, the power control apparatus 1 charges the storage battery 6 with the surplus power. In a case where (in a case where the summed power is less than power consumption) the summed power of power from the solar power generation apparatus 5 and power from the commercial power supply 4 is insufficient, the power control apparatus discharges the insufficient power from the storage battery 6. 3: The power control apparatus 1 supplies power from the solar power generation apparatus 5 to the power consumption apparatus 2 and in a case where power is insufficient, the power control apparatus 1 purchases insufficient power and otherwise, in a case where power is a surplus, the power control apparatus 1 charges the storage battery 6 with surplus power. In a case where power is purchased but the summed power of power from the solar power generation apparatus 5 and power from the commercial power supply 4 is insufficient, the power control apparatus 1 discharges insufficient power from the storage battery 6. 4: The power control apparatus 1 supplies power from the solar power generation apparatus 5 to the power consumption apparatus 2 and in a case where power is insufficient, the power control apparatus 1 purchases insufficient power and otherwise, in a case where power is in surplus, the power control apparatus 1 sells the surplus power. In a case where power is purchased but the summed power of power from the solar power generation apparatus 5 and power from the commercial power supply 4 is insufficient, the power control apparatus 1 discharges insufficient power from the storage battery 6. 5: The power control apparatus 1 discharges power from the storage battery 6 and sells power by setting surplus power calculated by subtracting power consumption from discharge power as an upper limit of the maximum power-selling power value in a contract. 6: The power control apparatus 1 charges the storage battery 6 with a power amount generated from the solar power generation apparatus 5. 7: The power control apparatus 1 does not perform power-selling and power-purchasing for the commercial power supply 4. The power control apparatus 1 supplies power to the power consumption apparatus 2 from the solar power generation apparatus 5 and in a case where power is insufficient, the power control apparatus 1 discharges insufficient power from the storage battery 6 and otherwise, in a case where power is a surplus, the power control apparatus 1 charges the storage battery 6 with surplus power. 8: The power control apparatus 1 does not perform power-selling and power-purchasing for the commercial power supply 4. The power control apparatus 1 supplies power to the power consumption apparatus 2 from the solar power generation apparatus 5 and in a case where power is insufficient, the power control apparatus 1 discharges insufficient power from the storage battery 6 and otherwise, in a case where power is a surplus, the power control apparatus 1 discards the surplus power.

Next, transition conditions of a state transition diagram illustrated in FIG. 2 will be described. As illustrated in FIG. 2, any one of (1) to (16) is added to solid line portions indicating state transitions (or state maintenances). In the following, state transition conditions (or maintenance conditions) of (1) to (16) will be described. Transition conditions of solid line portions are illustrated in FIG. 2. e indicates power of a commercial power supply, y indicates a total power consumption, s indicates solar power generation power, B indicates a power amount of a storage battery, v indicates a voltage of the commercial power supply. (1) e<contracted maximum power threshold value, (2) e=y−s<0, (3) e>contracted maximum power threshold value, (4) e=y−s>0, (5) B>storing power reference value #2, (6) B<storing power reference value #2, (7) B>storing power reference value #1, (8) B<storing power reference value #1, (9) B=full, (10) B<full, (11) B=depletion, (12) B>depletion, (13) v<voltage threshold value at a power failure, (14) v>voltage threshold value at a power failure, (15) v<voltage threshold value of power-selling, and (16) v>voltage threshold value of power-selling.

When a utilization reservation is received from the power consumption apparatus 2, the power management apparatus 3 increases the storing power reference value #2 in a process which will be described later. With this, the power control apparatus 1 preferentially reduce a range in which discharge and charge is performed and thus may avoid the residual amount of the storage battery 6 from being abruptly reduced by later power utilization, and may reduce the number of switching times of charge and discharge and a charge and discharge cycle amount. The charge and discharge cycle amount is a charge power amount or a discharge power amount per unit time.

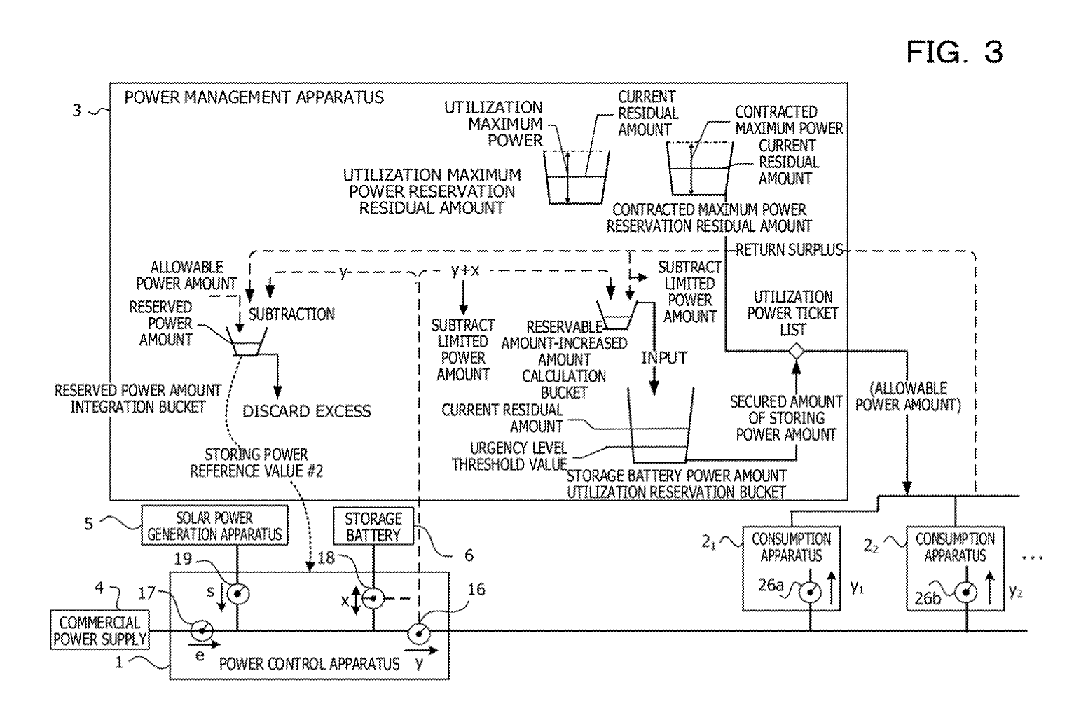

FIG. 3 is a diagram illustrating an example of a summary of operations of a system of Embodiment 1. When the power consumption apparatus 2 transmit a power utilization request message to the power management apparatus 3, the power management apparatus 3 makes a utilization reservation from at least one of a contracted maximum power reservation residual amount and a storage battery power amount utilization reservation bucket. The contracted maximum power reservation residual amount indicates power capable of being utilization-reserved from the commercial power supply 4. The storage battery power amount utilization reservation bucket indicates a power amount capable of being utilization-reserved from the storage battery 6. The power management apparatus 3 secures a requested power value from the utilization maximum power reservation residual amount and secures a requested power amount from at least one of the commercial power supply 4 and the storage battery 6. The power management apparatus 3 notifies the power consumption apparatus 2 of the secured power value (allowable power value) and the secured power amount (allowable power amount). The utilization maximum power reservation residual amount indicates a residual amount of the utilization maximum power which is the total amount of power utilizable by the power consumption apparatus 2 and the utilization maximum power is set by a user in advance.

When a utilization reservation is performed, the power management apparatus 3 records a utilization reservation situation in a utilization power ticket list. The power management apparatus 3 adds an allowable power amount (a power amount utilizable by the power consumption apparatus 2), which is a total of the utilization-reserved (secured) power amount, to the reserved power amount integration bucket. The power management apparatus 3 calculates a storing power reference value #2 which is used for control of charge and discharge of the storage battery 6 by the power control apparatus 1 based on the residual amount of the reserved power amount integration bucket.

The power consumption apparatus 2 notifies the power management apparatus 3 of the utilization residue power amount which is a power amount obtained by subtracting the amount of power consumption from the power amount of which the utilization reservation is made.

The power management apparatus 3 subtracts the utilization residue power amount from the reserved power amount integration bucket. The power management apparatus 3 adds an amount regarded as storage battery-supply power amount (Rwh), which corresponds to a storage battery power amount among the utilization residue power amount, to the reservable amount-increased amount calculation bucket. The power management apparatus 3 adds a residual amount of the reservable amount-increased amount calculation bucket to a storage battery power amount utilization reservation bucket. That is, the surplus of a stored power amount of which the utilization reservation is made is returned.

The power management apparatus 3 acquires a total power consumption (y) from the power meter 16 and acquires a charge power amount (xwh) of the storage battery 6 from the power meter 18. The power management apparatus 3 subtracts an Integrated amount (Zwh) of a limited power amount (Cwh) (a power amount of which the utilization reservation is made from the commercial power supply 4) from a total power consumption amount (ywh) per a predetermined time and adds a value obtained by adding a charge power amount (xwh) to the value (Rwh2) to the reservable amount-increased amount calculation bucket. The power management apparatus 3 acquires the total power consumption amount (ywh) of the power consumption apparatus 2 from the power meter 16 and subtracts the total power consumption amount (ywh) from the reserved power amount integration bucket.

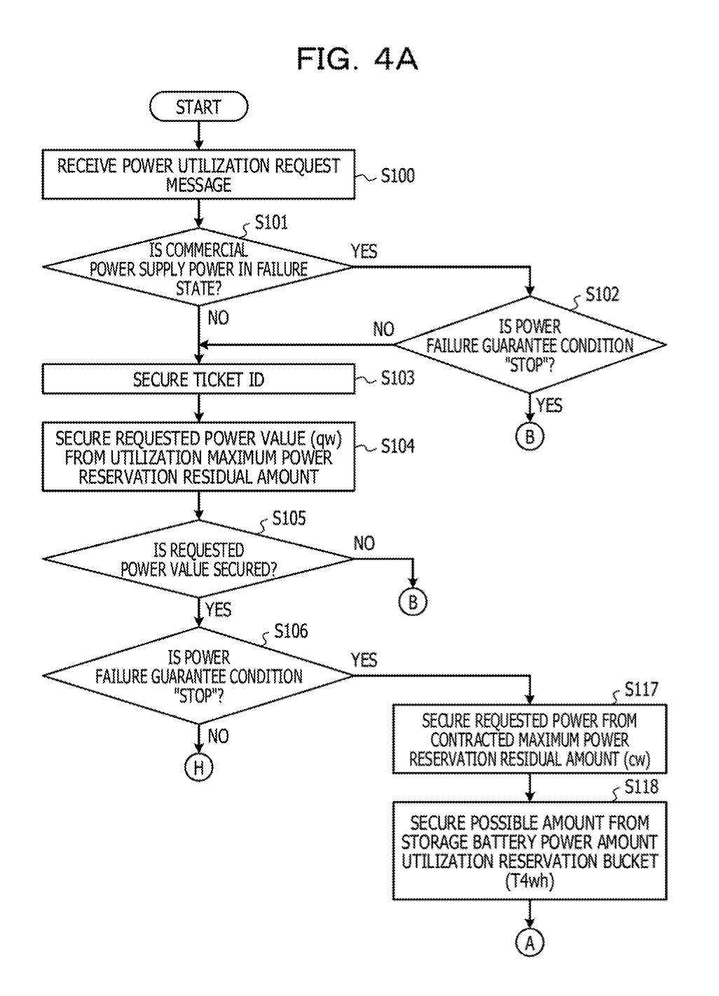

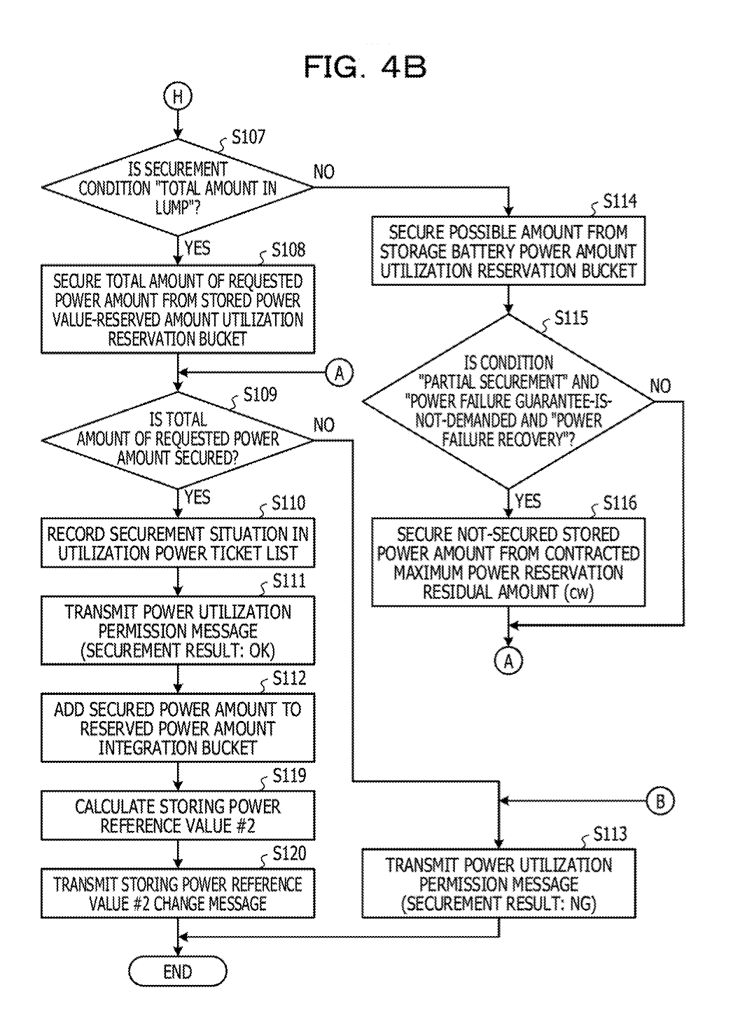

FIGS. 4A and 4B are flowcharts illustrating an example of a flow of a process (at the time of first reception) of the power management apparatus of Embodiment 1 when a power utilization request is received. A process of FIGS. 4A to 8 is started when a power utilization request message is transmitted from the power consumption apparatus 2 to the power management apparatus 3 for the first time. The power consumption apparatus 2 transmits a first power utilization request message, for example, when a power supply is turned on by a user.

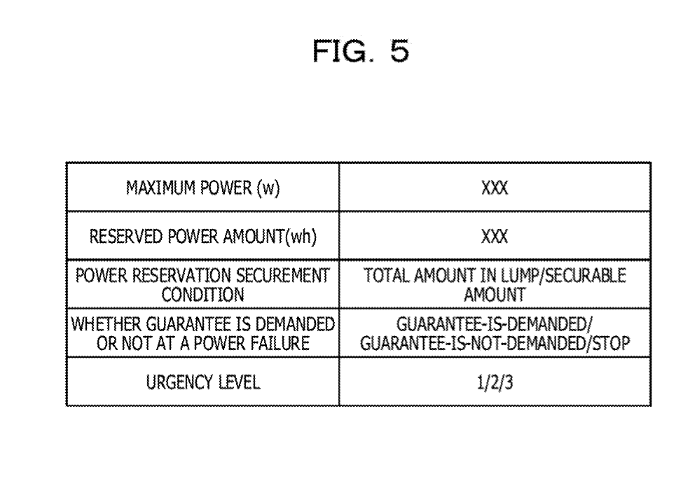

FIG. 5 is a diagram illustrating an example of a power reservation value table. The power reservation value table is a table which is stored in the storage unit 22 by the power consumption apparatus 2. As illustrated in FIG. 5, the power reservation value table includes a maximum power (w), a reserved power amount (wh), a power reservation securement condition, whether guarantee is demanded or not at a power failure, an urgency level. The maximum power indicates a maximum power value consumed by the power consumption apparatus 2.

The reserved power amount is determined based on an amount of power consumption for each functional unit which is set by a power-consumption equipment manufacturer and each functional unit which is set by a user in advance. For example, when the power consumption apparatus 2 is a rice cooking device, an equipment manufacturer stores a power amount for each mass to be subjected to rice cooking. When a user pours the rice and water into the rice cooking device, the rice cooking device measures the mass of the rice and water and calculates a reserved power amount using the power amount for each stored mass. For example, the power consumption apparatus 2 is the TV, the equipment manufacturer stores a power consumption for unit time in the TV. The user may store the shortest viewing time, which is considered comfortable by the user, in the TV. When the user turns a power supply of the TV ON, the TV calculates a reserved power amount based on a stored power consumption of a unit time and the viewing time.

A power reservation securement condition indicates whether a total amount of a reserved power amount is to be secured from the storage battery 6 in a lump (total amount in a lump) or may be secured by partial securement (securable amount) secured.

Whether guarantee is demanded or not at a power failure indicates a request regarding an operation at a power failure. A “guarantee-is-demanded” means that the power consumption apparatus 2 have to operate at a power failure. A “guarantee-is-not-demanded” means that although the power consumption apparatus 2 is intended to be operated at a power failure, a priority of the power consumption apparatus 2 is lower than an apparatus for which the “guarantee-is-demanded” is set preferentially. A “stop” means that the power consumption apparatus 2 is stopped at a power failure.

The urgency level indicates a level of urgency of the power consumption apparatus 2 and is set by the user in advance.

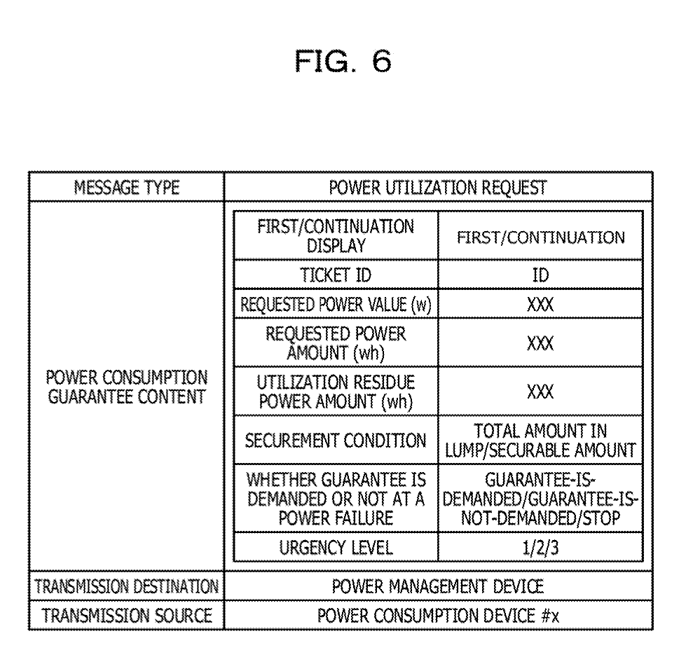

FIG. 6 is a diagram illustrating an example of a power utilization request message. As illustrated in FIG. 6, the power utilization request message includes information regarding a message type, a power consumption guarantee content, a transmission destination, and a transmission source. The power utilization request message is transmitted from the power consumption apparatus 2 to the power management apparatus 3.

The power consumption guarantee content includes an first/continuation display, a ticket ID, a requested power value (w), a requested power amount (wh), a utilization residue power amount (wh), a securement condition, a whether guarantee is demanded or not at a power failure, and an urgency level.

The first/continuation display indicates whether transmission of the power utilization request message is first transmission or a second or subsequent transmission (continuation). The ticket ID is a unique value for each power utilization request message. The requested power value (w) is set based on the maximum power of the power reservation value table. The requested power amount (wh) is set based on the reserved power amount of the power reservation value table. The utilization residue power amount indicates an unused power amount among the reserved power amount, but details thereof will be described later. The securement condition, whether guarantee is demanded or not at a power failure, and the urgency level are respectively set based on contents that are set in the power reservation value table.

The communication unit 33 of the power management apparatus 3 receives a power utilization request message from the power consumption apparatus 2 (Step S100). When the power utilization request message is received from the power consumption apparatus 2, the control unit 31 of the power management apparatus 3 confirms whether a state of the commercial power supply 4 is power failure or not (Step S101). The control unit 31 makes an inquiry to the power control apparatus 1 through, for example, the communication unit 33 to thereby confirm whether the commercial power supply 4 is in a power failure state or not, in Step S101.

In a case where it is confirmed that the commercial power supply 4 is in a power failure state (YES in Step S101), the control unit 31 confirms whether the power failure guarantee condition is the “stop” in the received power utilization request message (Step S102). In a case where the power failure guarantee condition is the “stop”, the process proceeds to Step S113 and the control unit 31 transmits the power utilization response message including a “securement result: NG” to the power consumption apparatus 2 through the communication unit 33.

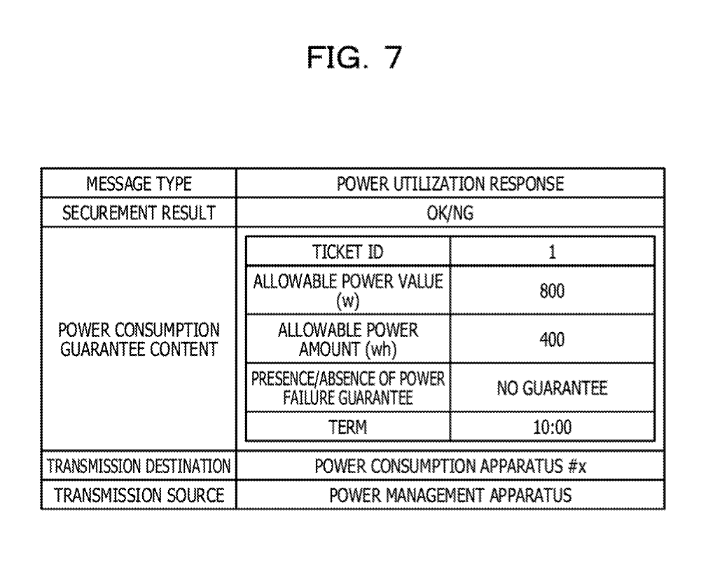

FIG. 7 is a diagram illustrating an example of a power utilization response message. As illustrated in FIG. 7, the power utilization response message includes information regarding the message type, a securement result, the power consumption guarantee content, the transmission destination, and the transmission source. The power consumption guarantee content indicates the ticket ID, an allowable power value (w), an allowable power amount (wh), presence/absence of power failure guarantee, and a period. The presence/absence of power failure guarantee is set based on the power failure guarantee condition in the power utilization request message. The period indicates a utilization period of the reserved power amount.

In a case where the securement result is “NG”, the allowable power value (w) and the allowable power amount (wh) are not described. Details of a calculation method of the allowable power value (w) and the allowable power amount (wh) in a case where the securement result is “OK” will be described later.

In a case where the commercial power supply 4 is not in the power failure state or the power failure guarantee condition is not the “stop” (NO in Step S101 or S102), the control unit 31 secures the ticket ID for the power utilization request message (Step S103). The control unit 31, in Step S103, issues a value unique for each power utilization request message as a ticket ID and stores the ticket ID in the storage unit 32.

The control unit 31 secures a requested power value (qw) of the power utilization request message from the utilization maximum power reservation residual amount (Step S104). For example, the control unit 31 subtracts the requested power value (qw) from the utilization maximum power reservation residual amount. In a case where the utilization maximum power reservation residual amount before being secured is greater than the requested power value (qw), the requested power value (qw) is securable, but in a case where the utilization maximum power reservation residual amount is less than the requested power value (qw), the requested power value (qw) is unsecurable.

The control unit 31 confirms whether the requested power value (qw) is securable (Step S105). In a case where the requested power value (qw) is unsecurable, the control unit 31 proceeds to Step S113 and subsequent Steps and transmits a power utilization response message including “securement result: NG” to the power consumption apparatus 2 through the communication unit 33.

The control unit 31 confirms whether the power failure guarantee condition is the “stop” In the power utilization request message (Step S106). In a case where the power failure guarantee condition is not the “stop”, power have to be secured from the storage battery 6 in order not to be stopped at a power failure and thus, the process proceeds to a process for securing power from the storage battery power amount utilization reservation bucket indicating a reservation residual amount of the storage battery 6.

In a case where the power failure guarantee condition is not the “stop”, (NO in Step S106), the control unit 31 confirms whether the securement condition is the “total amount in a lump” in the power utilization request message (Step S107). In a case where the securement condition is the “total amount in a lump”, the control unit 31 secures a total amount of the requested power amount according to the urgency level and the requested power amount from the storage battery power amount utilization reservation bucket (Step S108). The control unit 31 stores the secured power amount in the storage unit 32 as T4wh.

In the storage battery power amount utilization reservation bucket, a threshold value corresponding to the urgency level is set. When the requested power amount is subtracted from the storage battery power amount utilization reservation bucket and the subtraction result is lower than a predetermined threshold value, it becomes unsecurable (NO in Step S109 which will be described later). In the embodiment, threshold values 1, 2, and 3 corresponding to respective urgency levels 1, 2, and 3 are set. For example, in a case where the urgency level of the power utilization request message is 1, when the requested power amount is subtracted from the storage battery power amount utilization reservation bucket and the subtraction result is lower than the threshold value 1, it becomes unsecurable (NO in Step S109 which will be described later). A value of the corresponding threshold value becomes lower as the urgency level becomes higher.

The control unit 31 confirms whether a total amount of the requested power amount may be secured from the storage battery power amount utilization reservation bucket in Step S108 (Step S109). In a case where total amount of the requested power amount may be secured (YES in Step S109), the control unit 31 records the securement situation in the utilization power ticket list (Step S110).

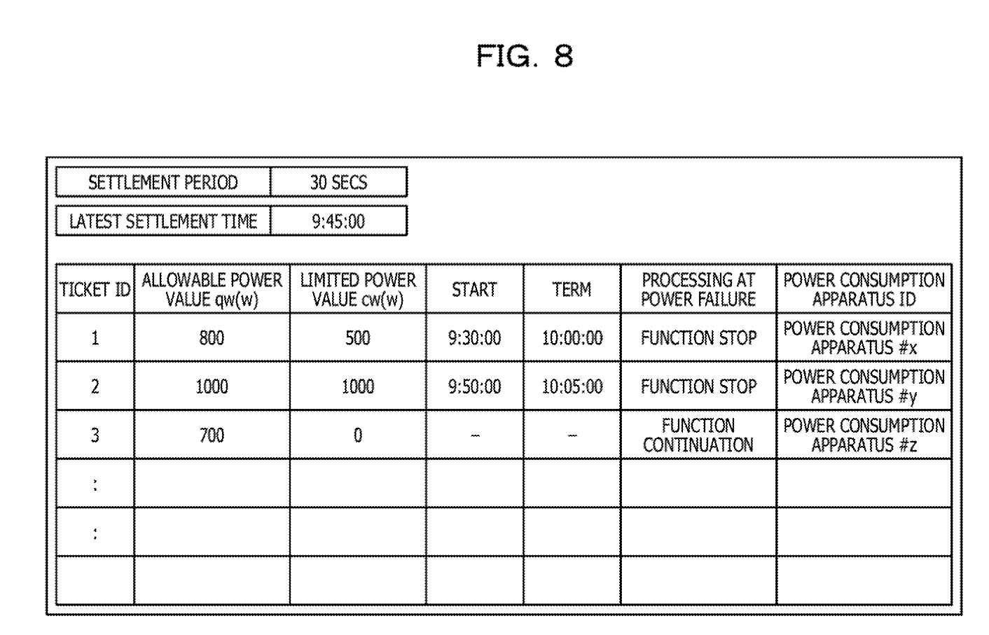

FIG. 8 is a diagram illustrating an example of a utilization power ticket list. The utilization power ticket list is stored in, for example, the storage unit 32 and a record is added in a case where power is secured for the request of the power consumption apparatus 2 in Step S103.

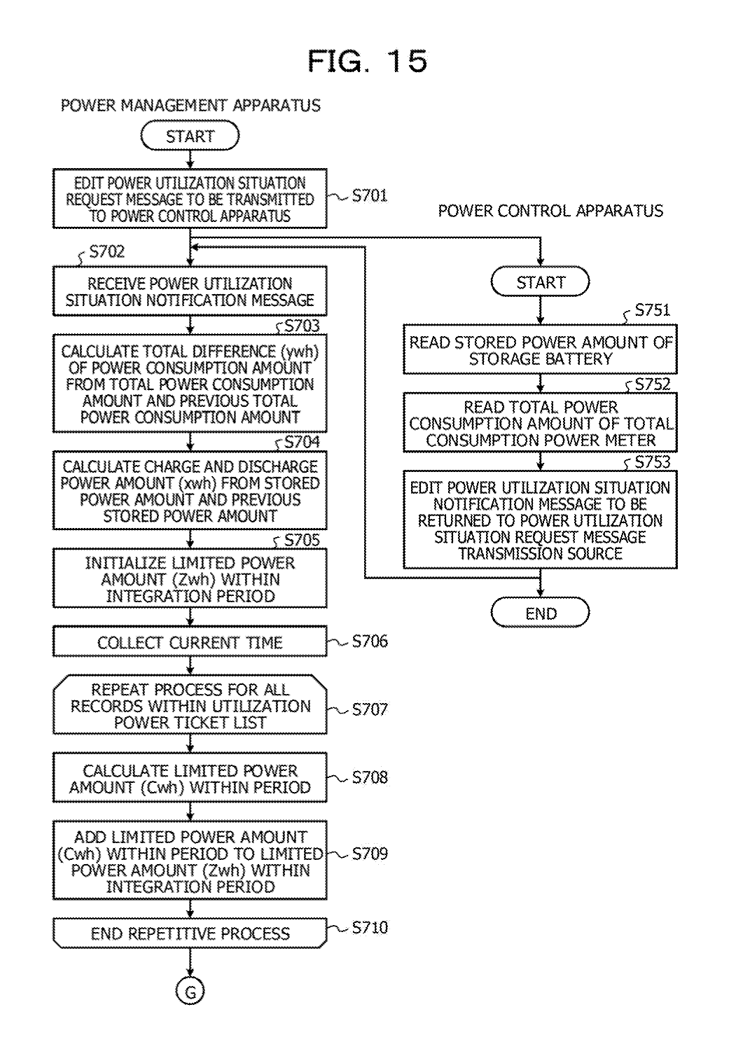

As illustrated in FIG. 8, the utilization power ticket list includes a settlement period and a latest settlement time. The settlement period indicates a period during which a periodic process illustrated in FIG. 15, which will be described later, is executed. The latest settlement time indicates the time at which the periodic process is executed most recently. Each record includes a ticket ID, an allowable power value qw(w), a limited power value cw(w), a start time, a period, processing-at-a-power-failure, and a power-consumption equipment ID. In the allowable power value, the power value (qw) secured in Step S104 is recorded. The limited power value cw(w) indicates the power value (cw) secured from the contracted maximum power reservation residual amount. In the start time, the time at which power is secured is set. The period indicates a secured utilization period of secured power. Processing at a power failure is set based on whether guarantee is demanded or not at a power failure of the power utilization request message. The power consumption apparatus ID indicates an ID which is set in a target power consumption apparatus 2 for which power is secured.

The control unit 31 records the ticket ID secured in Step S103, the allowable power value: qw, the limited power value: 0, the period: none, the operation-at-a-power failure: continuation of the function, in Step S110.

The control unit 31 edits the power utilization response message (set securement result: OK) and transmits the power utilization response message to the transmission source of the power utilization request message (Step S111). The control unit 31 describes the ticket ID secured in Step S103, the allowable power value: qw, the allowable power amount: T4wh, the period: none in the power utilization response message and transmits in the power utilization response message, in Step S111. The control unit 31 adds the secured power amount (T4wh) secured in Step S108 to the reserved power amount integration bucket (Step S112).

In a case where it is determined that the total amount may not be secured in Step S109, the control unit 31 transmits the power utilization response message including a securement result: NG to the power consumption apparatus 2, which is the power utilization request message transmission source, through the communication unit 33 (Step S113).

In a case where the securement condition is not the total amount in a lump in Step S107, that is, the securement condition is the “securable amount”, the control unit 31 secures a possible amount from the storage battery power amount utilization reservation bucket according to the requested power amount and the urgency level (Step S114). The control unit 31 stores the secured power amount in the storage unit 32 as the T4wh.

The control unit 31 confirms whether a portion of the requested power amount is secured (partial securement) in Step S114, and the power failure guarantee condition is the “guarantee-not-demanded” In the power utilization request message, and the commercial power supply 4 is not in the power failure state (power failure recovery state) (Step S115). In a case where all conditions of Step S115 are satisfied (YES in Step S115), it means that the total amount is not secured from the storage battery 6. For that reason, the control unit 31 secures power corresponding to the not-secured stored power amount from the contracted maximum power reservation residual amount (Step S116) and proceeds to Step S109. The contracted maximum power reservation residual amount indicates a residual amount of power securable from the commercial power supply 4. The control unit 31 stores the power value secured from the contracted maximum power reservation residual amount in the storage unit 32 as the cw. A requested power value (R_cw) secured in Step S116 is represented as in the following.

R_cw=(requested power amount−T4wh)*requested power value/requested power amount

In a case where the power failure guarantee condition is the “stop” in the power utilization request message (YES in Step S106), the control unit 31 secures the requested power value from the contracted maximum power reservation residual amount (Step S117). That is, the control unit 31 subtracts the requested power value from the contracted maximum power reservation residual amount. This is because in a case where the power failure guarantee condition is the “stop”, the operation is stopped at a power failure and thus power does not have to be secured from the storage battery 6. The control unit 31 temporarily stores the secured power in the storage unit 32 as the cw.

The control unit 31 secures a power amount corresponding to not-secured stored power amount from the storage battery power amount utilization reservation bucket according to the urgency level (Step S118) and proceeds to Step S109. A requested power amount (R_qwh) secured in Step S118 is represented as in the following. The control unit 31 stores the secured power amount in the storage unit 32 as the T4wh.

R_qwh=requested power amount*(1−cw/qw)

Next, a process in a case where the process proceeds from Step S116 or S118 to Step S110 to S112 will be described. The control unit 31 records the securement situation in the utilization power ticket list (Step S110). The control unit 31 records the ticket ID, the allowable power value: qw, the limited power value: cw, the start time: current time, the period: current time+T4wh/(qw−cw), the operation-at-a-power failure: function stop, in Step S110.

The control unit 31 edits the power utilization response message (set securement result as “OK”) and transmits the power utilization response message to the transmission source of the power utilization request message (Step S111). The control unit 31 describes the ticket ID secured in Step S103, the allowable power value: requested power value, the allowable power amount: T4wh/(1−cw/qw), the period: current time+T4wh/(qw−cw) in the power utilization response message, in Step S111. The control unit 31 adds the secured power amount (T4wh/(1−cw/qw)) to the reserved power amount integration bucket (Step S112).

The control unit 31 calculates the storing power reference value #2 based on the residual amount of the reserved power amount integration bucket, after processing of Step S112 (Step S119). The storing power reference value #2 is represented as in the following equation. A storing power reference value #2 base is an initial value of the storing power reference value #2 and the same value as, for example, the storing power reference value #1 is used.

storing power reference value #2=max{storing power reference value #1,reserved power amount integration bucket+storing power reference value #2 base}

The control unit 31 edits a change message including a value of the calculated storing power reference value #2 and transmits the change message to the power control apparatus 1 (Step S120).

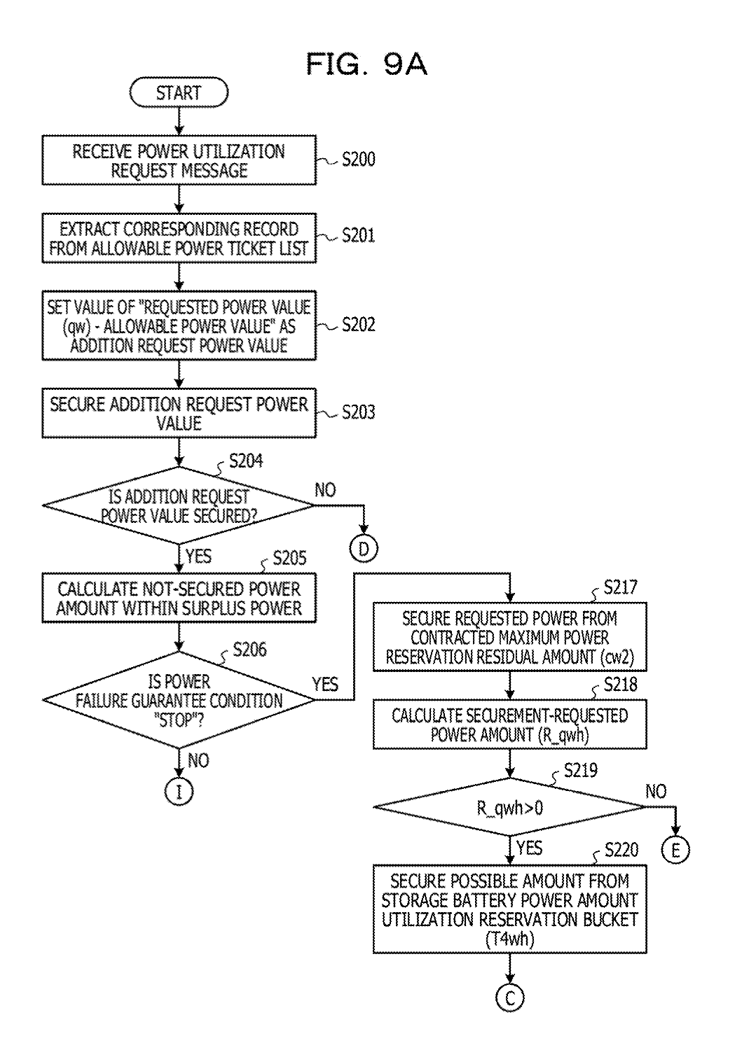

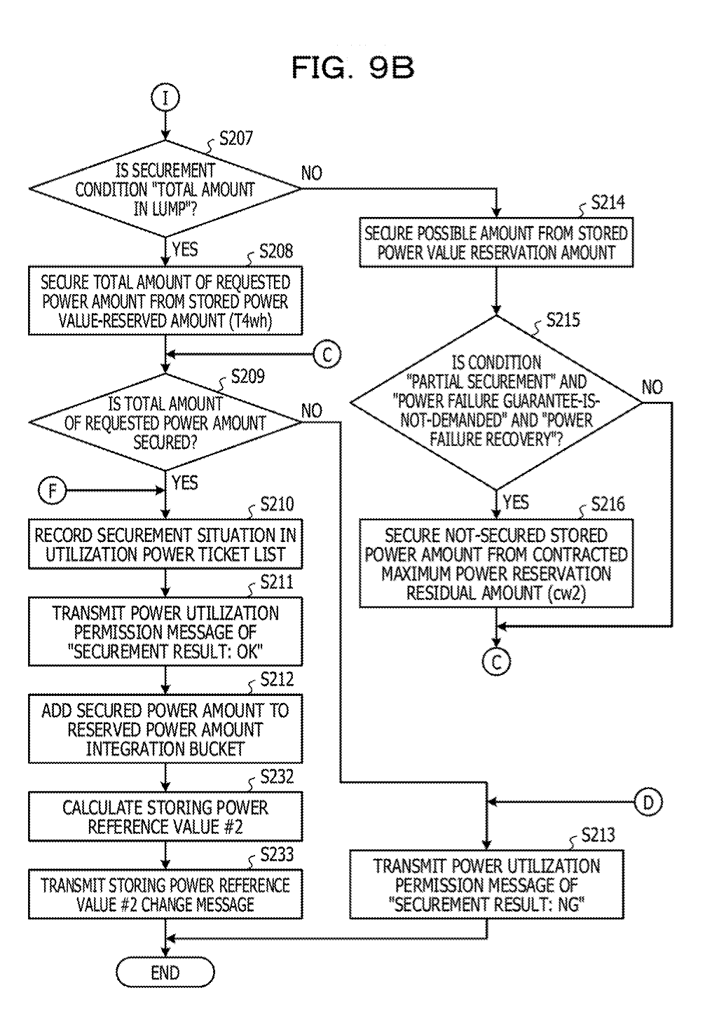

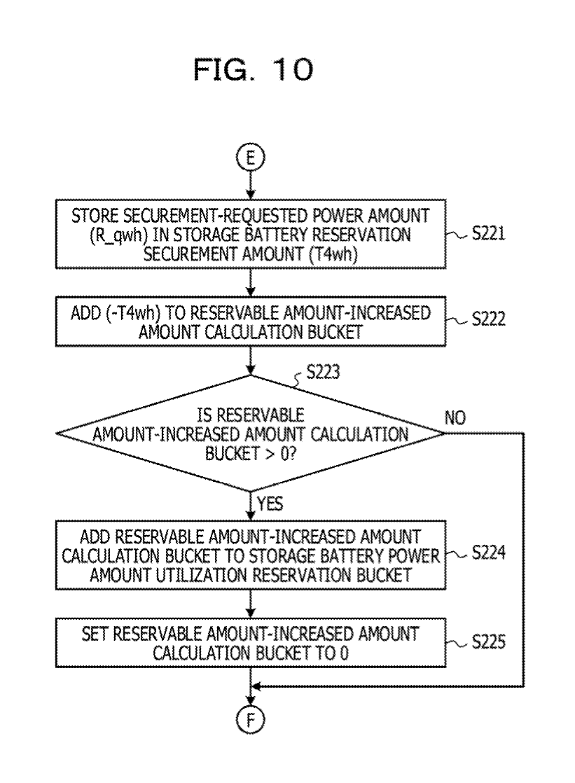

FIGS. 9A, 9B and 10 are flowcharts illustrating an example of a flow of a process (at the time of continuous reception) of a power management apparatus of Embodiment 1 when a power utilization request is received. A process of FIG. 9A is started when a power utilization request message which requests continuous utilization (“continuation” is described in the field of first/continuation) is transmitted from the power consumption apparatus 2 to the power management apparatus 3.

The communication unit 33 of the power management apparatus 3 receives the power utilization request message from the power consumption apparatus 2 (Step S200). When the power utilization request message is received, the control unit 31 collates an ID to extract a record corresponding to the power utilization request message from the allowable power ticket list (Step S201). The control unit 31 sets a value obtained by subtracting an allowable power value of the allowable power ticket list from a requested power value (qw) of the power utilization request message as an addition request power value (Step S202).

The control unit 31 secures the addition request power value which is set in Step S202 from the utilization maximum power reservation residual amount (Step S203). In a case where the addition request power value is a negative value, the control unit 31 returns (add) the addition request power value to the utilization maximum power reservation residual amount in Step S203.

The control unit 31 confirms whether the addition request power value may be secured from the utilization maximum power reservation residual amount (Step S204). For example, the control unit 31 confirms whether the utilization maximum power reservation residual amount before being secured is greater than the addition request power value. In a case where the addition request power value may be secured (YES in Step S204), the control unit 31 calculates a limited power amount (Cwh) within a surplus power amount as in the following (Step S205).

Cwh=cw*(term−max(latest settlement time,start time))

The control unit 31 confirms whether the power failure guarantee condition is the “stop” in the power utilization request message (Step S206). In a case where the power failure guarantee condition is not the “stop”, power have to be secured from the storage battery 6 in order not to be stopped at a power failure at thus, the process proceeds to the process for securing power from the storage battery 6.

In a case where the power failure guarantee condition is not the “stop” (NO in Step S206), the control unit 31 confirms whether the securement condition is a “total amount in a lump” in the power utilization request message (Step S207). In a case where the securement condition is the “total amount in a lump”, the control unit 31 secures a total amount of [requested power amount+Cwh] from the storage battery power amount utilization reservation bucket according to the [requested power amount+Cwh] and the urgency level (Step S208). The control unit 31 temporarily stores the secured power amount in the storage unit 32 as T4wh.

The control unit 31 confirms whether the total amount may be secured in Step S208 (Step S209). In a case where the total amount may be secured (YES in Step S209), the control unit 31 records the securement situation in the utilization power ticket list (Step S210). The control unit 31 records the ticket ID of the record extracted in Step S201, the allowable power value: qw, the limited power value: 0, the period: none, and the operation-at-a-power failure: continuation of the function, in Step S210.

The control unit 31 edits the power utilization response message (set securement result as “OK”) and transmits the power utilization response message to the transmission source of the power utilization request message (Step S211). The control unit 31 describes the ticket ID, the allowable power value: qw, the allowable power amount: T4wh−Cwh, and the period: none, in the power utilization response message in Step S211. The control unit 31 adds the secured power amount (T4wh−Cwh) to the reserved power amount integration bucket (Step S212).

In a case where the total amount may not be secured in Step S209, the control unit 31 transmits the power utilization response message including the securement result: NG to the power consumption apparatus 2, which is the power utilization request message transmission source, through the communication unit 33 (Step S213).

In a case where the securement condition is not the total amount in a lump in Step S207, that is, in a case where the securement condition is the “securable amount”, the control unit 31 secures a possible amount from the storage battery power amount utilization reservation bucket according to the [requested power amount+Cwh] and the urgency level (Step S214). The control unit 31 temporarily stores the secured power amount in the storage unit 32 as T4wh.

The control unit 31 confirms whether a portion of the requested power amount is secured (partial securement) in Step S214, and the power failure guarantee condition is the “guarantee-not-demanded” in the power utilization request message, and the commercial power supply 4 is not in the power failure state (power failure recovery state) (Step S215). In a case where all conditions of Step S215 are satisfied (YES in Step S215), it means that the total amount is not secured from the storage battery 6. For that reason, the control unit 31 secures power corresponding to the not-secured stored power amount from the contracted maximum power reservation residual amount (Step S216) and proceeds to Step S209 and subsequent Steps. The control unit 31 stores the power value secured from the contracted maximum power reservation residual amount in the storage unit 32 as cw2. A requested power value (R_cw) secured in Step S116 is represented as in the following.

R_cw=(requested power amount−T4wh+Cwh)*requested power value/(requested power amount+utilization residue power amount)

In a case where the power failure guarantee condition is the “stop” in the power utilization request message (YES in Step S206), the control unit 31 secures the requested power value from the contracted maximum power reservation residual amount (Step S217). This is because in a case where the power failure guarantee condition is the “stop”, the operation is stopped at a power failure and thus power does not have to be secured from the storage battery 6. The control unit 31 temporarily stores the secured power in the storage unit 32 as the cw2.

The control unit 31 calculates a securement-requested power amount (R_qwh) as a power amount corresponding to not-secured stored power amount (Step S218). The securement-requested power amount (R_qwh) is represented as in the following equation.

R_qwh=requested power amount*(1−cw2/qw)−utilization residue power amount+Cwh

The control unit 31 determines whether securement-requested power amount (R_qwh)>0 is satisfied or not (Step S219). In a case where securement-requested power amount (R_qwh)>0 is satisfied (YES in Step S219), the control unit 31 secures a possible amount from the storage battery power amount utilization reservation bucket according to the securement-requested power amount (R_qwh) and the urgency level (Step S220) and proceeds to Step S209. The control unit 31 stores the secured power amount in the storage unit 32 as the T4wh.

In a case where securement-requested power amount R_qwh>0 is not satisfied (NO in Step S219), the control unit 31 stores the securement-requested power amount R_qwh in the storage battery reservation securement amount T4wh (Step S221). The case where securement-requested power amount R_qwh>0 is not satisfied means that the power amount of which the utilization reservation is made remains without being used up in the power consumption apparatus 2. For that reason, the control unit 31 returns the surplus power amount to the storage battery power amount utilization reservation bucket in next steps Step S222 to S225.

The control unit 31 adds −T4wh to the reservable amount-increased amount calculation bucket (Step S222). In a case where reservable amount-increased amount calculation bucket >0 is satisfied (Step S223), the control unit 31 adds the residual amount of the reservable amount-increased amount calculation bucket to the storage battery power amount utilization reservation bucket (Step S224). The control unit 31 sets the residual amount of the reservable amount-increased amount calculation bucket as 0 (Step S225).

Next, a process in a case where the process proceeds from Step S216, S220, or S225 to Step S210 to S212 will be described.

The control unit 31 records the securement situation in the utilization power ticket list (Step S210). The control unit 31 records the ticket ID, the allowable power value: qw, the limited power value: cw2, the start time: current time, the period: current time+(utilization residue power amount+T4wh−Cwh)/(qw−cw), the operation-at-a-power failure: function stop, of the record extracted in Step S201, in Step S210.

The control unit 31 edits the power utilization response message (set securement result as “OK”) and transmits the power utilization response message to the transmission source of the power utilization request message (Step S211). The control unit 31 describes the ticket ID, the allowable power value: requested power value, the allowable power amount: (utilization residue power amount+T4wh−Cwh)/(1−cw/qw)−utilization residue power amount, of the record extracted in Step S201 in the power utilization response message, in Step S211. The control unit 31 describes the period: current time+(utilization residue power amount+T4wh−Cwh)/(qw−cw) in the power utilization response message, in Step S211.

The control unit 31 adds the secured power amount (utilization residue power amount+T4wh−Cwh)/(1−cw/qw)−utilization residue power amount) to the reserved power amount integration bucket (Step S212).

The control unit 31 calculates the storing power reference value #2 based on the residual amount of the reserved power amount integration bucket, after processing of Step S212 (Step S232). The storing power reference value #2 is represented as in the following equation. The storing power reference value #2 base is an initial value of the storing power reference value #2 and for example, the same value as the storing power reference value #1 is used.

storing power reference value #2=max{storing power reference value #1,reserved power amount integration bucket+storing power reference value #2 base}

The control unit 31 edits a change message including a value of the calculated storing power reference value #2 and transmits the change message to the power control apparatus 1 (Step S233).

As described above, according to the procedure illustrated in FIGS. 9A, 9B and 10, the storing power reference value #2 is updated according to the utilization reservation information (power utilization request message) transmitted from the power consumption apparatus 2.

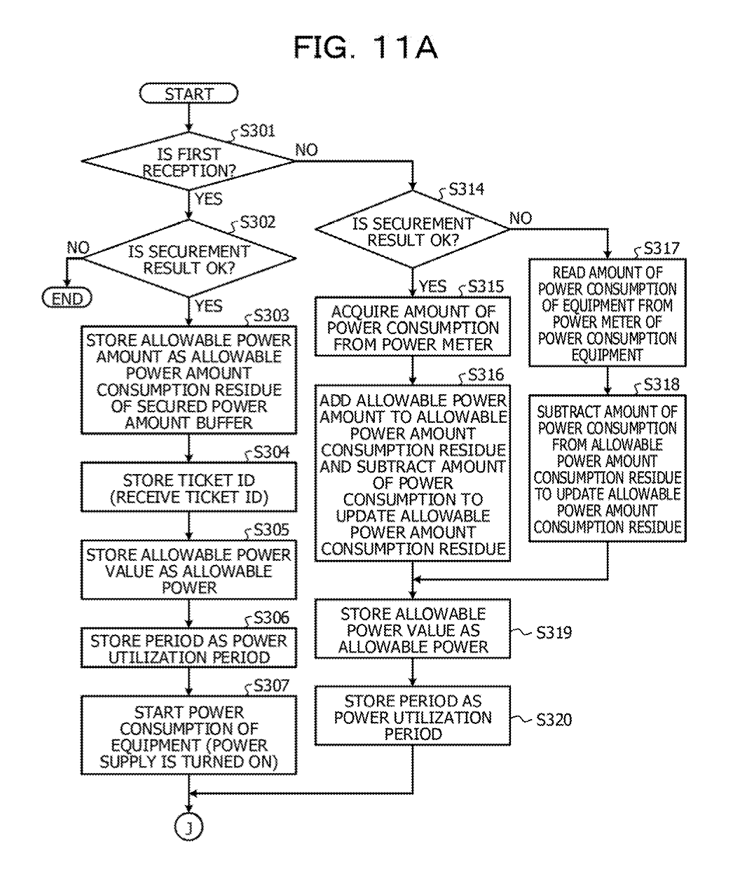

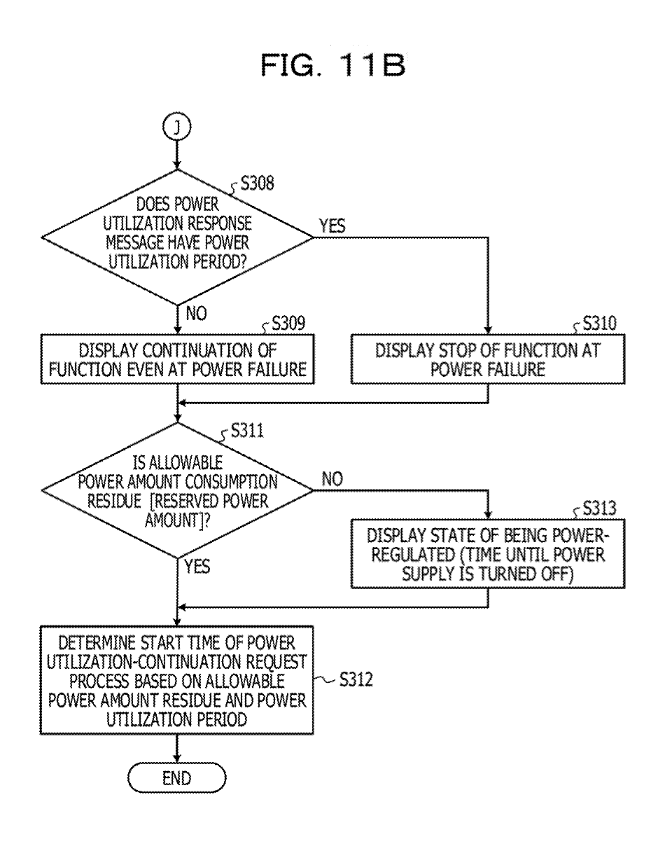

FIGS. 11A and 11B are flowcharts illustrating an example of a process in a case where a power consumption apparatus receives a power utilization response message. The control unit 21 of the power consumption apparatus 2 determines whether reception of a power utilization response message is first (Step S301). For example, the control unit 21 confirms whether the ticket ID is already stored in the storage unit 22.

In a case where the reception of a power utilization response message is first, the control unit 21 determines whether the securement result is OK (Step S302). In a case where the securement result is OK, the control unit 21 stores the allowable power amount of the power utilization response message in the storage unit 22 as an allowable power amount consumption residue (Step S303). The allowable power amount consumption residue indicates an unused power amount among the allowable power amount which is a power amount of which utilization is permitted from the power management apparatus 3

The control unit 21 stores the ticket ID of the power utilization response message in the storage unit 22 (Step S304). The control unit 21 stores the allowable power value of the power utilization response message in the storage unit 22 as allowable power (Step S305). The control unit 21 stores the period of the power utilization response message in the storage unit 22 as a power utilization period (Step S306). The control unit 21 notifies the power load control unit 27 that power may be consumed. The power load control unit 27 turns the power supply of equipment ON to start power consumption (Step S307).

The control unit 21 determines whether the power utilization period is present in the power utilization response message (Step S308). The control unit 21 determines whether time is described in the [term] of the power utilization response message in Step S308.

In a case where the power utilization period is not present (NO in Step S308), the control unit 21 displays contents indicating that the function continues even at a power failure on the display device 28 (Step S309). In a case where the power utilization period is present (YES in Step S308), the control unit 21 displays contents indicating that the function is stopped even at a power failure on the display device 28 (Step S309).

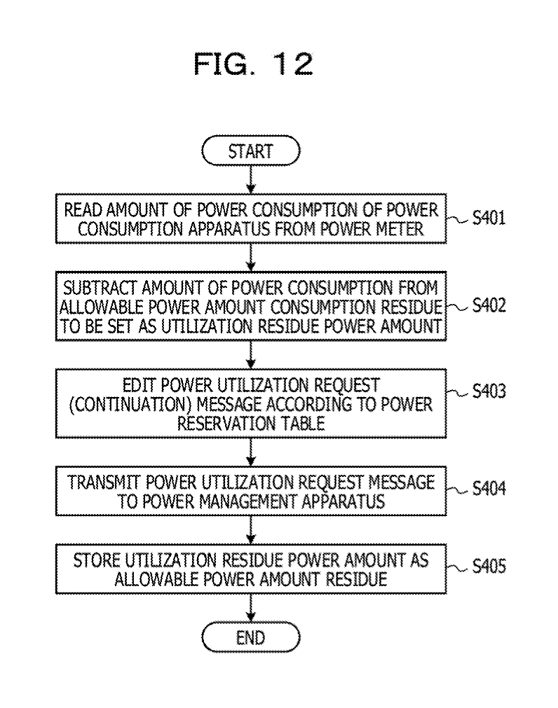

The control unit 21 determines whether the allowable power amount consumption residue≧the reserved power amount is satisfied (Step S311). The reserved power amount is a value recorded in the power reservation value table indicated in FIG. 5. In a case where the allowable power amount consumption residue≧the reserved power amount is satisfied, the control unit 21 determines the start time of a power utilization-continuation request process illustrated in FIG. 12 based on the allowable power amount residue and the power utilization period (Step S312). The control unit 21 sets the start time of the power utilization-continuation request process as, for example, the time before a predetermined period of time of the power utilization period. The power utilization-continuation request process will be described later. In a case where the allowable power amount consumption residue z the reserved power amount is satisfied, the control unit 21 displays matters that power is in a state of being regulated and the time until the power supply is turned OFF on the display unit 28 (Step S313).

In a case where the reception of the power utilization response message is not first (NO in Step S301), the control unit 21 determines whether the securement result of the power utilization response message is “OK” (Step S314). In a case where the securement result of the power utilization response message is “OK” (YES in Step S314), the control unit 21 acquires the amount of power consumption from the power meter 26 (Step S315). The control unit 21 adds the allowable power amount to the allowable power amount consumption residue, subtracts the amount of power consumption, and updates the allowable power amount consumption residue (Step S316).

In a case where the securement result is “NG” (NO in Step S314), the control unit 21 acquires the amount of power consumption from the power meter 26 (Step S317). The control unit 21 subtracts the amount of power consumption from the allowable power amount consumption residue and updates the allowable power amount consumption residue (Step S318).

After processing of Step S316 or Step S318, the control unit 21 stores the allowable power value of the power utilization response message in the storage unit 22 as the allowable power (Step S319). The control unit 21 stores the period of the power utilization response message in the storage unit 22 as the power utilization period (Step S320).

When the power utilization response message is received, the power consumption apparatus 2 may display contents of the message on the display unit 28.

FIG. 12 is a flowchart illustrating an example of a power utilization-continuation request process by the power consumption apparatus. The power utilization-continuation request process illustrated in FIG. 12 is started, for example, at the time determined in processing in Step S312 of FIG. 11B. The power utilization-continuation request process may be periodically activated.

The control unit 21 of the power consumption apparatus 2 acquires the amount of power consumption from the power meter 26 of the power consumption apparatus 2 (Step S401). The control unit 21 subtracts the amount of power consumption from the allowable power amount consumption residue to be stored in the storage unit 22 as the utilization residue power amount (Step S402).

The control unit 21 edits the power utilization request message according to the power reservation table (Step S403). The control unit 21 sets “continuation” in the field of first/continuation of the power utilization request message and sets the value calculated in Step S402 as the utilization residue power amount.

The control unit 21 transmits the power utilization request message edited in Step S403 to the power management apparatus 3 (Step S404). The control unit 21 stores the utilization residue power amount as the allowable power amount residue (Step S405).

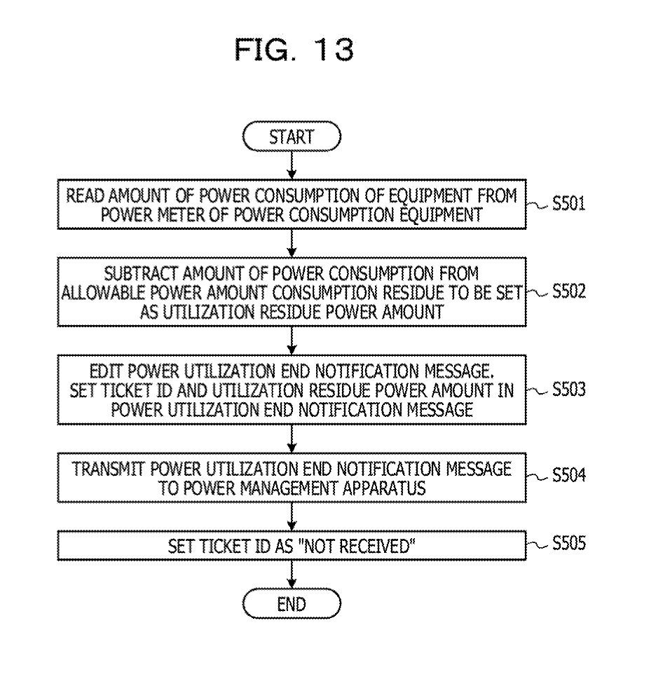

FIG. 13 is a flowchart illustrating a process of the power consumption apparatus when power utilization is ended. The process illustrated in FIG. 13 is started when the operation of the power consumption apparatus 2 is ended. End of the operation of the power consumption apparatus 2 is conducted by automatic stoppage of an apparatus or an end operation of a user.

The control unit 21 of the power consumption apparatus 2 acquires the amount of power consumption from the power meter 26 (Step S501). The control unit 21 subtracts the amount of power consumption from the allowable power amount consumption residue to be stored in the storage unit 22 as the utilization residue power amount (Step S502).

The control unit 21 edits the power utilization end notification message. The control unit 21 sets the ticket ID stored in Step S304 of FIG. 11A and the utilization residue power amount in the power utilization end notification message (Step S503). The control unit 21 transmits the power utilization end notification message to the power management apparatus 3 (Step S504). The control unit 21 stores the ticket ID in the storage unit 22 as a ticket ID not received (Step S505). With this, in a case where the next power utilization request message is transmitted, first/continuation display becomes the “first”.

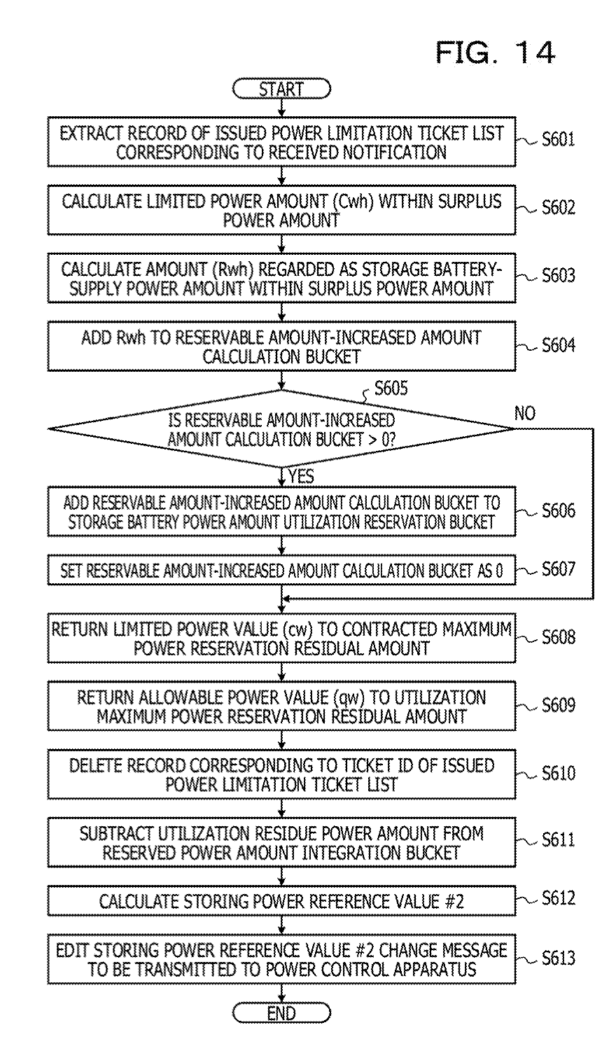

FIG. 14 is a flowchart illustrating an example of a process when the power management apparatus of Embodiment 1 receives a power utilization end notification from the power consumption apparatus. The control unit 31 of the power management apparatus 3 acquires a record including a ticket ID corresponding to the ticket ID of the received power utilization end notification from the utilization power ticket list (Step S601).

The control unit 31 calculates the limited power amount (Cwh) within the surplus power amount as in the following (Step S602).

Cwh=cw*(term−max(start time,latest settlement time))

The control unit 31 calculates the amount (Rwh) regarded as storage battery-supply power amount within the surplus power amount as in the following (Step S603).

Rwh=utilization residue power amount−Cwh

The control unit 31 adds the Rwh to the reservable amount-increased amount calculation bucket (Step S604) and determines whether the reservable amount-increased amount calculation bucket >0 is satisfied (Step S605). In a case where the reservable amount-increased amount calculation bucket >0 is satisfied (YES in Step S605), the control unit 31 adds the reservable amount-increased amount calculation bucket residual amount to the storage battery power amount utilization reservation bucket (Step S606). The power amount indicated in the reservable amount-increased amount calculation bucket was moved to the storage battery power amount utilization reservation bucket and thus the control unit 31 sets the reservable amount-increased amount calculation bucket as 0 (Step S607).

In Steps S604 to S607 as described above, the control unit 31 returns the amount regarded as storage battery-supply power amount within the surplus power amount to the storage battery power amount utilization reservation bucket. That is, a power amount which amounts to the power amount secured (utilization is reserved) from the storage battery 6 among the power amount, of which the utilization reservation is made by the power consumption apparatus 2 but which is unused, is returned to the storage battery power amount utilization reservation bucket.

The control unit 31 returns (adds) the limited power value (cw) of the utilization power ticket list to the contracted maximum power reservation residual amount (Step S608). The control unit 31 returns (adds) the allowable power value (qw) to the utilization maximum power reservation residual amount (Step S609). The control unit 31 deletes a record including a ticket ID corresponding to the ticket ID of the received power utilization end notification from the utilization power ticket list (Step S610).

The control unit 31 subtracts the utilization residue power amount from the reserved power amount integration bucket (Step S611). The control unit 31 calculates the storing power reference value #2 as in the following and updates the storing power reference value #2 (Step S612).

storing power reference value #2=max{storing power reference value #1,reserved power amount integration bucket+storing power reference value #2 base}

The control unit 31 edits the storing power reference value #2 change message including the calculated storing power reference value #2 and transmits the storing power reference value #2 change message to the power control apparatus 1 (Step S613).

By the process illustrated in FIG. 14, the power management apparatus 3 updates the storage battery power amount utilization reservation bucket to update the storing power reference value #2, using the utilization residue power amount notified from the power consumption apparatus 2. With this, the power management apparatus 3 may calculate the optimum storing power reference value #2 according to the latest utilization situation of the power consumption apparatus 2.

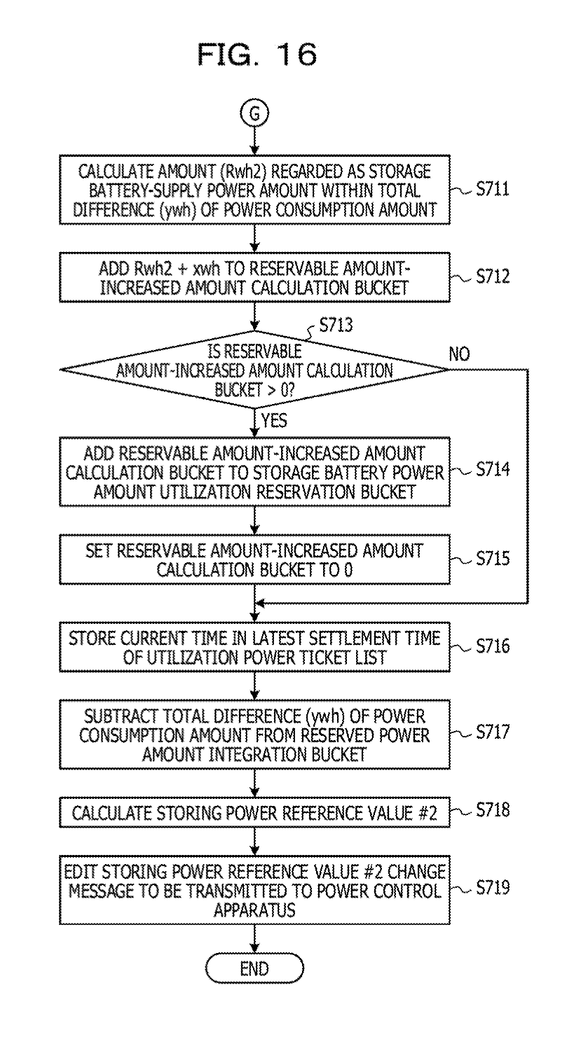

FIGS. 15 and 16 are flowcharts illustrating a process periodically performed by the power management apparatus and the power control apparatus of Embodiment 1. The control unit 31 of the power management apparatus 3 edits the power utilization situation request message which requests for transmission of a power utilization situation. The communication unit 33 transmits the power utilization situation request message to the power control apparatus 1 (Step S701).

When the power utilization situation request message is received, the communication unit 13 of the power control apparatus 1 acquires the stored power amount (residual amount) of the storage battery 6 from the power meter 18 (Step S751). The communication unit 13 knows the total power consumption amount of the power consumption apparatus 2 and thus, acquires the power amount from the power meter 16 (Step S752). The control unit 11 of the power control apparatus 1 edits the power utilization situation notification message including the stored power amount and the total power consumption amount of the storage battery 6. The communication unit 13 returns the power utilization situation notification message to the power utilization situation request message transmission source (power management apparatus 3) (Step S753).

The communication unit 33 of the power management apparatus 3 receives the power utilization situation notification message transmitted from the power control apparatus 1 (Step S702). The control unit 31 subtracts the previous total power consumption amount from the total power consumption amount described in the transmitted power utilization situation notification message to calculate the total difference (ywh) of power consumption amount (Step S703).

The control unit 31 subtracts the previous stored power amount from the stored power amount described in the transmitted power utilization situation notification message to calculate the charge and discharge power amount (xwh) (Step S704). The charge and discharge power amount (xwh) is a value which becomes positive in charging and becomes negative in discharging. The control unit 31 initializes the limited power amount (Zwh) within the integration period (Step S705). The limited power amount (Zwh) within the integration period will be described later. In a case where the limited power amount (Zwh) within the integration period is not yet calculated, the control unit 31 does not perform processing of Step S705.

The control unit 31 acquires the current time from the dock management unit 35 (Step S706). The control unit 31 starts a repetitive process for all records within the utilization power ticket list (Step S707). The control unit 31 calculates the limited power amount (Cwh) within the surplus power amount as in the following (Step S708).

Cwh=cw*(current time−Max(latest settlement time,start time))

The control unit 31 adds the limited power amount (Cwh) within a period to the limited power amount (Zwh) within the Integration period (Step S709). After performing processing of Steps S708 and S709 for all the records within the utilization power ticket list, the control unit 31 ends the repetitive process (Step S710).

The control unit 31 calculates an amount (Rwh2) regarded as the storage battery-supply power amount within the total difference (ywh) of power consumption amount.

Rwh2=ywh−Zwh (Step S711)

The control unit 31 adds the Rwh2+xwh to the reservable amount-increased amount calculation bucket (Step S712). The Rwh2 is added because an amount corresponding to a used power amount within the power amount, of which the utilization reservation is made by the power consumption apparatus 2, is allocated to a new power utilization request. The xwh is added so as to be allocated to the new power utilization request according to charge and discharge of the storage battery 6.

The control unit 31 confirms whether the reservable amount-increased amount calculation bucket >0 is satisfied (Step S713). In a case where the reservable amount-increased amount calculation bucket >0 is satisfied (YES in Step S713), the control unit 31 adds the reservable amount-increased amount calculation bucket residual amount to the storage battery power amount utilization reservation bucket (Step S714), and sets the reservable amount-increased amount calculation bucket as 0 (Step S715).

The control unit 31 returns the amount regarded as the storage battery-supply power amount within the total power consumption difference to the storage battery power amount utilization reservation bucket and adds an amount of charge and discharge (positive: in charging), through processing of Steps S712 to S715.

The control unit 31 records the current time in the latest settlement time of the utilization power ticket list (Step S716). The control unit 31 subtracts the total difference (ywh) of power consumption amount from the reserved power amount integration bucket (Step S717).

The control unit 31 calculates the storing power reference value #2 as in the following, using the reserved power amount integration bucket updated in Step S717 (Step S718).

storing power reference value #2=max{storing power reference value #1,reserved power amount integration bucket+storing power reference value #2 base}

The control unit 31 updates (edits) the storing power reference value #2 of the storing power reference value #2 change message. Accordingly, the communication unit 33 transmits the storing power reference value #2 change message to the power control apparatus 1 (Step S719).

By the process described above, the power management apparatus 3 acquires an amount of actual power consumption from the power control apparatus 1 and updates the storing power reference value #2 based on the power consumption. With this, the power management apparatus 3 may update the storing power reference value #2 with a suitable value obtained by taking latest power consumption into account without increasing communications with the power consumption apparatus 2.

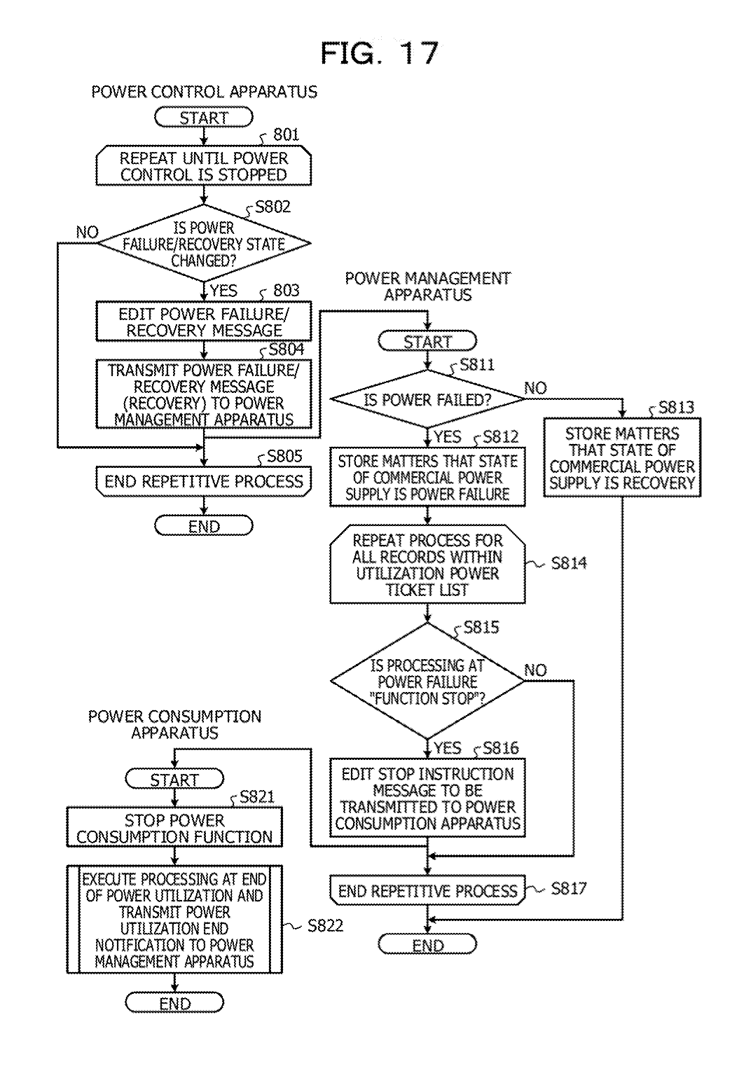

FIG. 17 is a flowchart illustrating a process of the power control apparatus, the power consumption apparatus, and the power management apparatus at a power failure and at a recovery from power failure. The power control apparatus 1 starts a repetitive process until power control is stopped (Step S801).

The power control apparatus 1 waits until the commercial power supply 4 is recovered from the power failure (Step S802). In a case where the commercial power supply 4 becomes a recovery state, the power control apparatus 1 edits the power failure/recovery message (recovery) and transmits the power failure/recovery message (recovery) to the power management apparatus 3 (Step S803). The power failure/recovery message includes information indicating whether the commercial power supply 4 is in the power failure state or the recovery state.

The power control apparatus 1 waits until the commercial power supply 4 becomes the power failure state from the recovery state (Step S804). In a case where the commercial power supply 4 becomes the power failure state, the power control apparatus 1 edits the power failure/recovery message (power failure) and transmits the power failure/recovery message (power failure) to the power management apparatus 3 (Step S805).

The power control apparatus 1 ends the repetitive process when power control is ended (Step S806).

When the power failure/recovery message is received, the power management apparatus 3 determines whether a state of the commercial power supply 4 indicated by the content of the message is power failure (Step S811). In a case where the state of the commercial power supply 4 is power failure (YES in Step S811), the power management apparatus 3 stores matters that the state of the commercial power supply 4 is the power failure state in the storage unit 32 (Step S812). In a case where the state of the commercial power supply 4 is not power failure (NO in Step S811), the power management apparatus 3 stores matters that the state of the commercial power supply 4 is the recovery state in the storage unit 32 (Step S813).

The power management apparatus 3 starts a repetitive process for all records within the utilization power ticket list (Step S814). The power management apparatus 3 determines whether processing at a power failure is the “function stop” in the utilization power ticket list (Step S815). In a case of the “function stop” (YES in Step S815), the power management apparatus 3 edits the stop instruction message and transmits the stop instruction message to the power consumption apparatus 2 (Step S816). In a case where the processes of Steps S815 and S816 are completed for all records, the power management apparatus 3 ends the repetitive process (Step S817).

The power management apparatus 3 may set the power consumption apparatus 2 of which the processing-at-a-power-failure is the “function stop” in the utilization power ticket list as a multicast transmission destination in advance. With this, the power management apparatus 3 may transmit the stop instruction message at a time by the multicast function and thus, a process in transmission may be simplified.

When the stop instruction message is received from the power management apparatus 3, the power consumption apparatus 2 stops the power consumption function (Step S821). The power consumption apparatus 2 executes the process when power utilization is ended illustrated in FIG. 13 and transmits the power utilization end notification to the power management apparatus 3 (Step S822).

Next, an example in which respective values described in the processes described above are represented by calculation formulas will be described. ₄T is the storage battery power amount utilization reservation bucket, ₅T is the reserved power amount integration bucket, ₂Tᵢ is the utilization residue power amount of the power consumption apparatus 2ᵢ, Yᵢ is the allowable power amount (reservation value) of the power consumption apparatus 2ᵢ, and ₄tᵢ is the storage battery reserved power amount to the power consumption apparatus 2ᵢ. Cᵢ(t) is the limited power value (reservation value) of the power consumption apparatus 2ᵢ, yᵢ(t) is a used power value (actual results) of the power consumption apparatus 2ᵢ, y(t) is the total power consumption amount, x(t) is the charge and discharge power value of the storage battery 6 (becomes positive in charging), X is the stored power amount (actual results), and X₀ is the stored power amount (Initial value).

The stored power amount X is represented as in the following formula (1-1).

X=X₀+∫x(t)dt (1-1)

The total power consumption amount y(t) is represented as in the following formula (1-2).

y(t)=yᵢ(t) (1-2)

The utilization residue power amount ₂Tᵢ is represented as in the following formula (1-3).

₂Tᵢ=Yᵢ−∫yᵢ(t)dt (1-3)

The allowable power amount (reservation value) Yᵢ is represented as in the following formula (1-4).

Yᵢ=₄tᵢ+∫cᵢ(t)dt (1-4)

The storage battery power amount utilization reservation bucket ₄T is represented as in the following formula (1-5).

$$\begin{matrix}{}_{4} T = {X}_{0} - \sum {}_{4}^{}{t}{}_{i}^{} + \int y ( t ) dt + \int X ( t ) dt - \sum \int {c}_{i} ( t ) dt \\ = {X}_{0} + \int x ( t ) dt - \sum ( {}_{4}^{}{i}{}_{i}^{} + {C}_{i} - \int {y}_{i} ( t ) dt ) + \sum ( {C}_{i} - \int {c}_{i} ( t ) dt ) \\ = X - \sum {}_{2}^{}{T}{}_{i}^{} + \sum ( {C}_{i} - \int {c}_{i} ( t ) dt )\end{matrix} \qquad ( 1 \text{-} 5 )$$

The reserved power amount integration bucket ₅T is represented as in the following formula (1-6).

₅T=ΣYᵢ−∫y(t)dt=Σ₂Tᵢ (1-6)

₄T+₅T is represented as in the following formula (1-7).

₄T+₅T=X+Σ(Cᵢ−∫cᵢ(t)dt) (1-7)

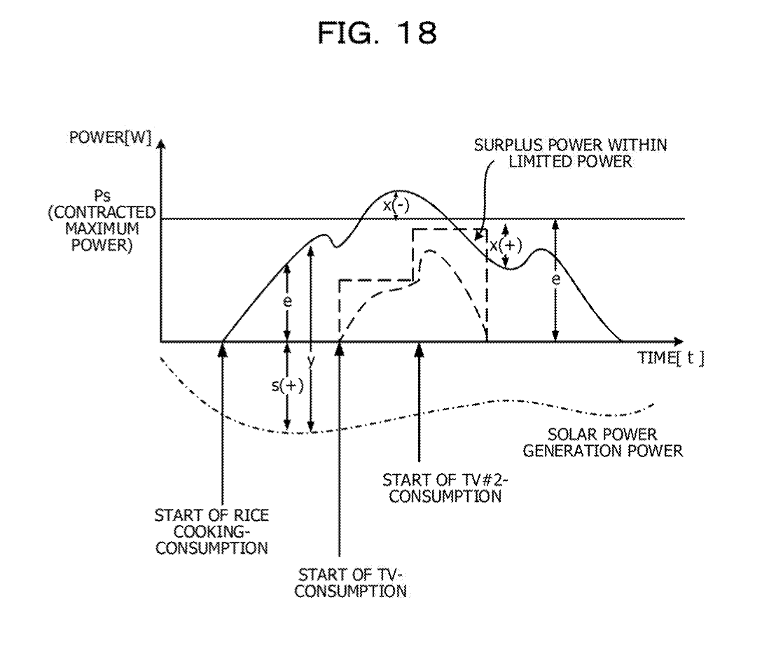

FIG. 18 is a graph illustrating an example of power consumption including power consumption without guarantee against a power failure (reserved power amount of storage battery). In FIG. 18, a solid line curve indicates the total power consumption of the power consumption apparatus 2. A straight-line of a broken line indicates power (limited power) of which the utilization reservation is made from the commercial power supply 4. A curve of a broken line indicates power consumption of TV #1 and TV #2. The TV #1 and TV #2 make a utilization reservation for using power of the commercial power supply 4 and power within the limited power is used for TV #1 and TV #2. An alternate long and short dash line indicates power (s) generated by solar power generation, and indicates that power becomes greater as the alternate long and short dash line propagates downward.

Consumption by TV is started after consumption for rice cooking is started and power is supplied from power (e) of the commercial power supply 4 and power (s) of the solar power generation apparatus 5 to each power-consumption equipment until contracted maximum power of the commercial power supply 4 is exceeded. When the power consumption exceeds the contracted maximum power of the commercial power supply 4, power is supplied to each power-consumption equipment from the storage battery 6 from which discharge (x(−)) of the storage battery 6 is performed.

Thereafter, the residual amount of the storage battery 6 becomes lower than the power storage specified value #1 by discharge. When power consumption is reduced and becomes lower than the contracted maximum power again, charge to the storage battery 6 (x(+)) is performed by the surplus power of the commercial power supply 4.

According to the power management apparatus of the embodiment, a reference value used for control of charge and discharge is calculated based on the utilization reservation situation of the power consumption apparatus and the reference value is updated. With this, the power control apparatus 1 reduces the range in which charge and discharge are preferentially performed and thus, the number of switching times of charge and discharge at the charge and discharge cycle amount such that the life of the storage battery may be prolonged.

According to the power management apparatus of the embodiment, power for a power consumption apparatus (for example, an apparatus guaranteed at a power failure), which is not allowed to stop, is preferentially secured from the storage battery at a power failure. In a case where the power for the power consumption apparatus is not secured, the operation of the power consumption apparatus is not started. In a case where the operation is started, the power consumption apparatus is able to continue the operation even when the power failure occurs and the operation of the power consumption apparatus within an allowed power consumption range is not avoided even when an operation of another power consumption apparatus is newly started optionally.

The user may know the time to stop the power consumption apparatus in advance by the period which is set by the power management apparatus. The user of the power consumption apparatus may know whether the function is stopped or not at a power failure, in advance. The power management apparatus measures power consumption and charge and discharge power of the power consumption apparatus and manages a utilization situation and thus, does not have to make an inquiry to another power consumption apparatus about the utilization residue of the allowable power amount of another power consumption apparatus each time when power utilization is requested from each power consumption apparatus. For that reason, a communication amount for controlling adjustment of power consumption may be reduced.

### Embodiment 2

In the following, Embodiment 2 will be described with reference to the accompanying drawings. Description will be mainly made on portions different from Embodiment 1 in the following description. It is regarded that configurations not particularly described are similar to those of Embodiment 1. A configuration of a system of Embodiment 2 is similar to the configuration illustrated in FIG. 1.

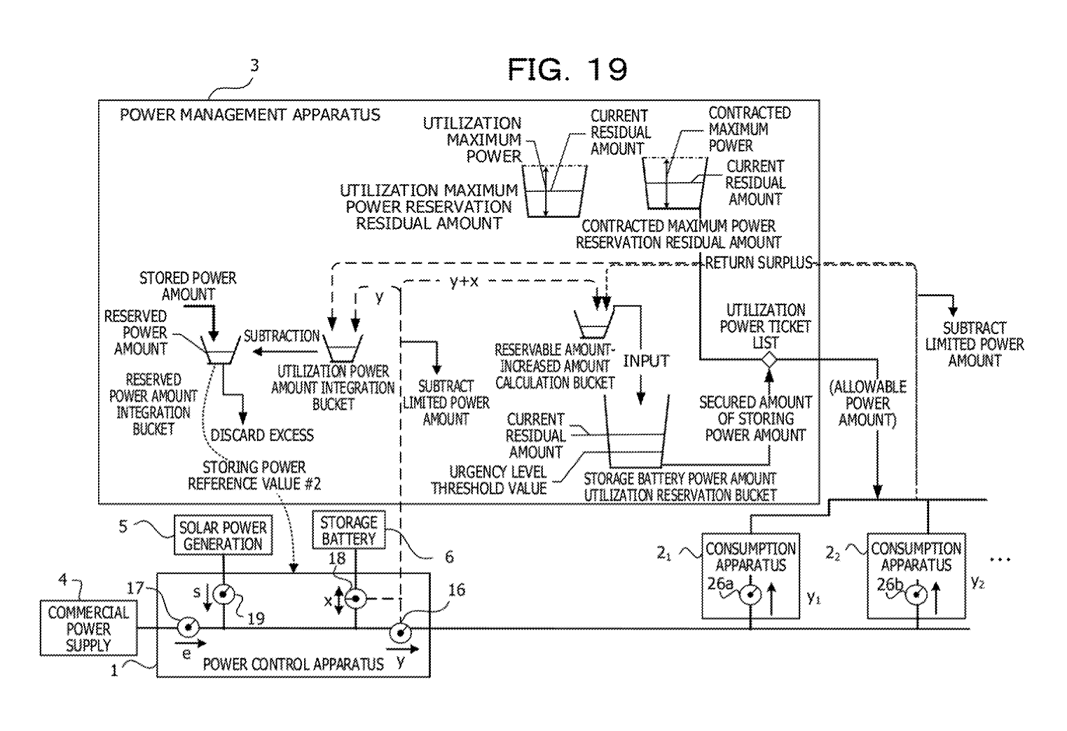

FIG. 19 is a diagram illustrating an example of a summary of operations of a system of Embodiment 2. In the following, description will be made on a portion different from the summary of operations of Embodiment 1 illustrated in FIG. 3.

The power management apparatus 3 adds the stored power amount of which the utilization reservation is made for the power consumption apparatus 2 to the reserved power amount integration bucket. The power management apparatus 3 adds a value (Rwh) obtained by subtracting the limited power amount (Cwh) (power amount of which the utilization reservation is made from a utilization reservation commercial power supply 4) from the utilization residue power amount, which is obtained from the power consumption apparatus 2, to the utilized power amount integration bucket.

The power management apparatus 3 adds a value (Rwh2) obtained by subtracting the integrated amount (Zwh) of the limited power amount (Cwh) from the total power consumption amount (ywh) of the power consumption apparatus 2 per a predetermined time to the utilized power amount integration bucket. The residual amount of the utilized power amount integration bucket is input to the reserved power integration bucket.

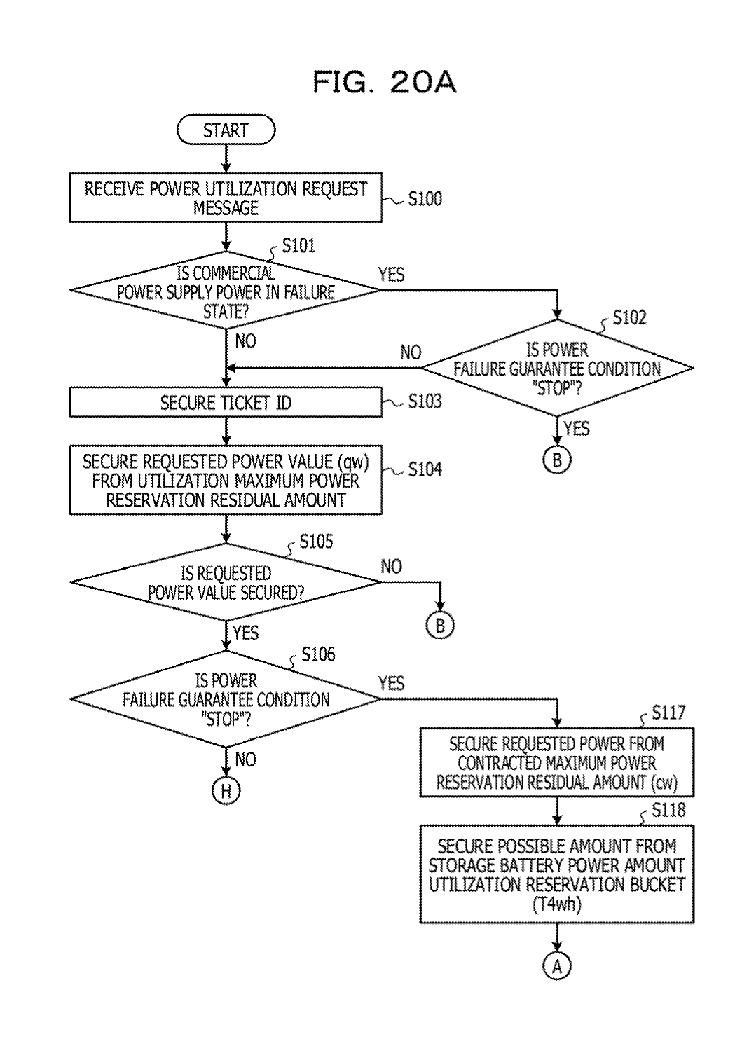

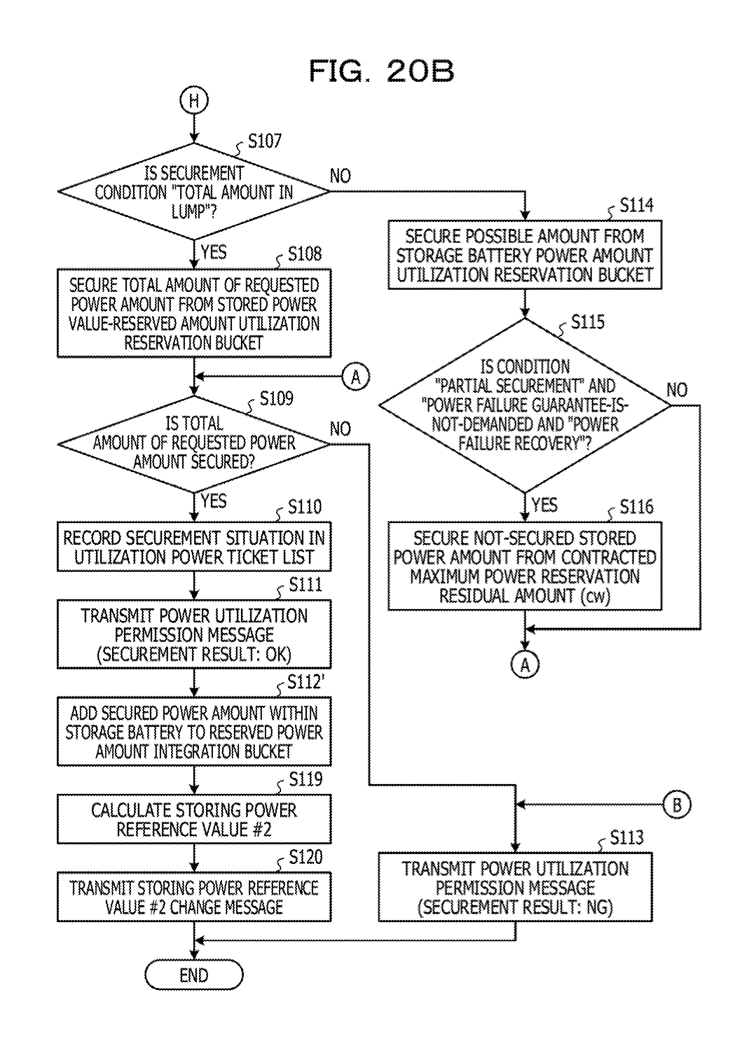

Next, operations of the power management system of Embodiment 2 will be described using a flowchart. FIGS. 20A and 20B are flowcharts illustrating an example of a flow of a process (at the time of first reception) of a power management apparatus of Embodiment 2 when a power utilization request is received. The process illustrated in FIG. 20B is different from the process illustrated in FIG. 4B of Embodiment 1 in that Step S112′ is performed instead of Step S112.

In Embodiment 1, the control unit 31 adds the secured power amount (T4wh) (in a case where the process proceeds from Step S116 or S118, (T4wh/(1−cw/qw))) to the reserved power amount integration bucket, in Step S112. On the other hand, in Embodiment 2, even in a case where the process proceeds from either of Step S116 or S118, the control unit 31 adds the secured power amount T4wh within the storage battery to the reserved power amount integration bucket, in Step S112′.

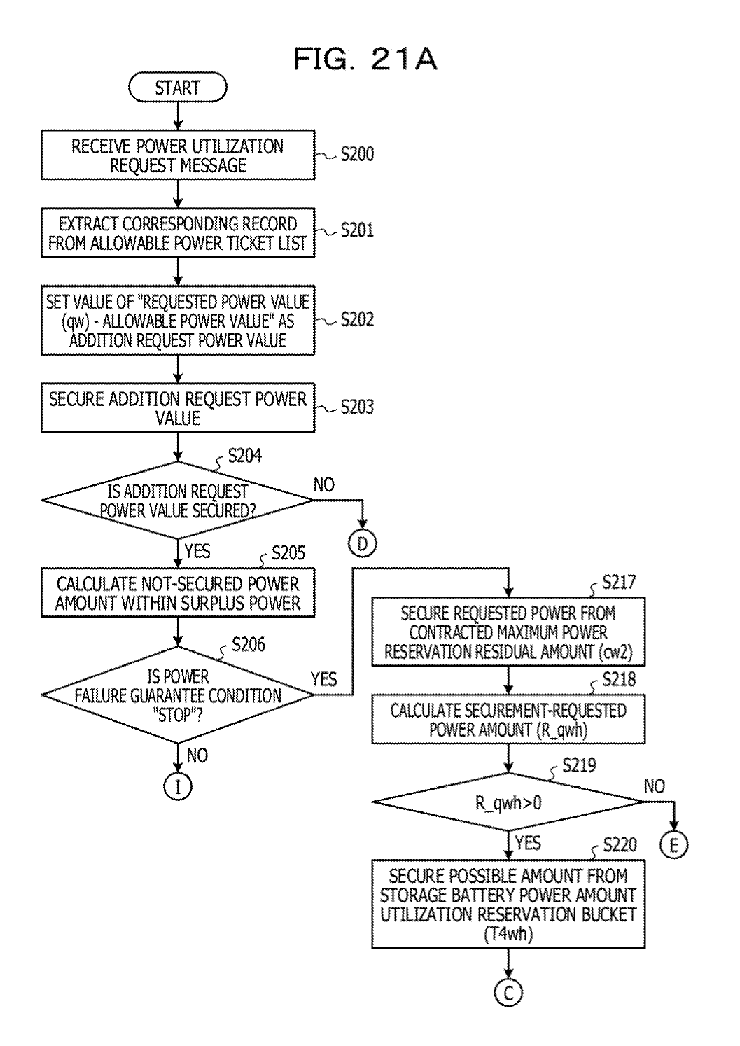

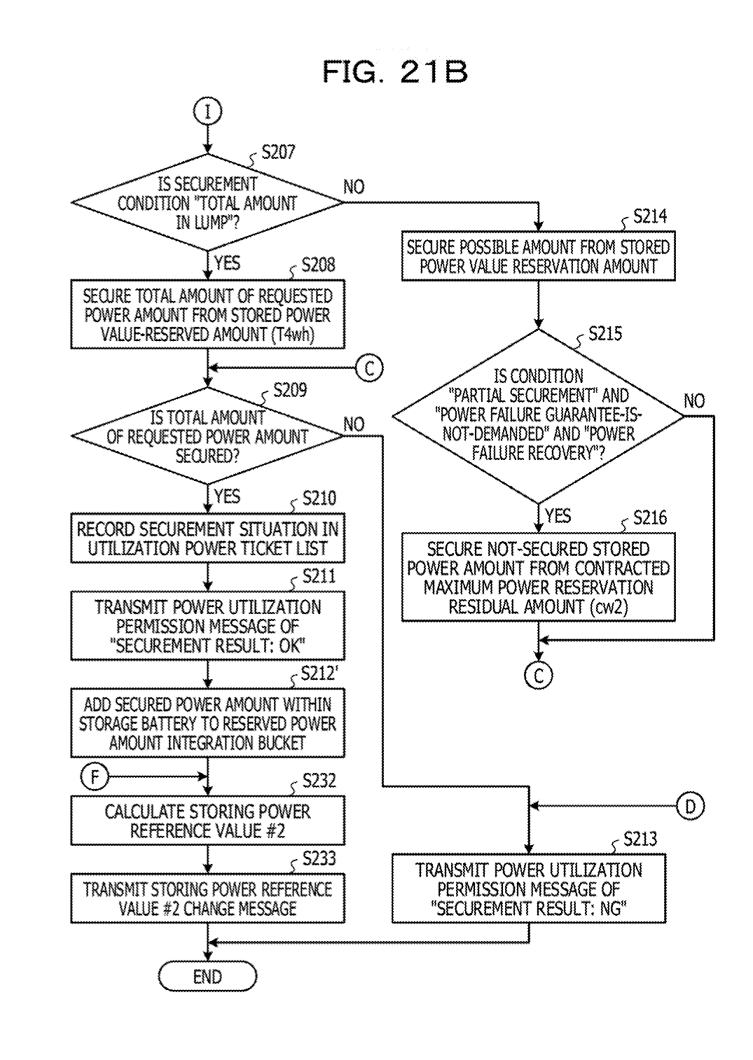

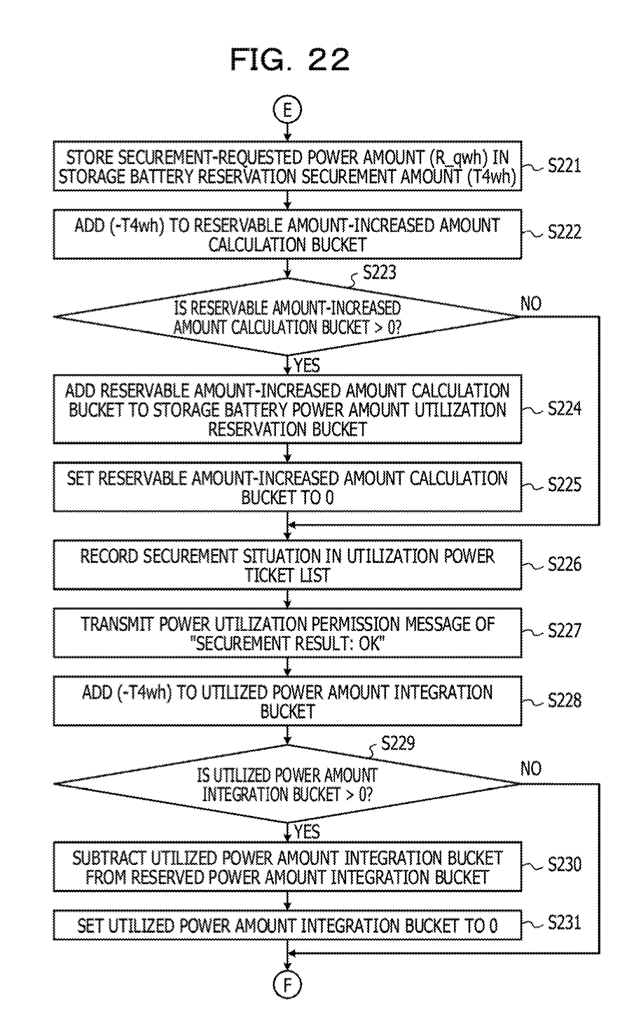

FIGS. 21A, 21B and 22 are flowcharts illustrating an example of a flow of a process (at the time of continuous reception) of a power management apparatus of Embodiment 2 when a power utilization request is received. The process illustrated in FIGS. 21A, 21B and 22 is different from the process illustrated in FIG. 9B of Embodiment 1 in that Step S212′ is performed instead of Step S212.

In Embodiment 1, the control unit 31 adds the secured power amount (T4wh−Cwh) to the reserved power amount integration bucket, in Step S212. In a case where the process proceeds from Step S216, S220, or S225 to Step S212, the control unit 31 adds the secured power amount (utilization residue power amount+T4wh−Cwh)/(1−cw/qw)−utilization residue power amount) to the reserved power amount integration bucket. On the other hand, in Embodiment 2, even in a case where the process proceeds from one of Step S216, S220, or S225, the control unit 31 adds the secured power amount T4wh within the storage battery to the reserved power amount integration bucket in Step S212′.

As described above, the power management apparatus 3 of Embodiment 2 adds the secured power amount within the storage battery to the reserved power amount integration bucket and calculates the storing power reference value #2 used for charge and discharge control based on the residual amount of the reserved power amount integration bucket after the addition. That is, the power management apparatus 3 updates the storing power reference value #2 based on the secured power amount within the storage battery indicating an amount to be discharged from the storage battery 6 in future and thus, a more suitable the storing power reference value #2 may be set.

Although the process proceeds to Step S210 after Step S225 in Embodiment 1, matters that Steps S226 to Step S231 are added after Step S225 and then, the process proceeds to Step S232 In Embodiment 2 are different from Embodiment 1. In the following, processing of Step S226 to Step S231 will be described.

The control unit 31 records the securement situation in the utilization power ticket list (Step S226). The control unit 31 records the ticket ID, the allowable power value: qw, the limited power: cw2, the start time: current time, the period: current time+(utilization residue power amount+T4wh−Cwh)/(qw−cw), the operation-at-a-power failure: function stop, of a record extracted in Step S201, in Step S226.

The control unit 31 edits the power utilization response message (sets securement result as OK) and transmits the power utilization response message to the transmission source of the power utilization request message (Step S227). The control unit 31 describes the ticket ID, the allowable power value: requested power value, the allowable power amount: (utilization residue power amount+T4wh−Cwh)/(1−cw/qw)−utilization residue power amount, and the period: current time+(utilization residue power amount+T4wh−Cwh)/(qw−cw) of the record extracted in Step S201 in the power utilization response message, in Step S217.

The control unit 31 adds (−T4wh) to the utilized power amount integration bucket (Step S228). The control unit 31 determines whether the utilized power amount integration bucket >0 is satisfied (Step S229). In a case where the utilized power amount integration bucket >0 is satisfied (YES in Step S229), the control unit 31 subtracts the utilized power amount integration bucket residual amount from the reserved power amount integration bucket (Step S230) and sets the utilized power amount integration bucket as 0 (Step S231). The control unit 31 proceeds to Step S219 after Step S231.

As described above, in Embodiment 2, in a case of the surplus, the power amount (T4wh) which amounts to the storage battery power amount within the surplus power amount is subtracted from the reserved power integration bucket. Accordingly, the power management apparatus 3 of Embodiment 2 may suitably update the storing power reference value #2 in the process when a power utilization request is received (at the time of continuous reception).

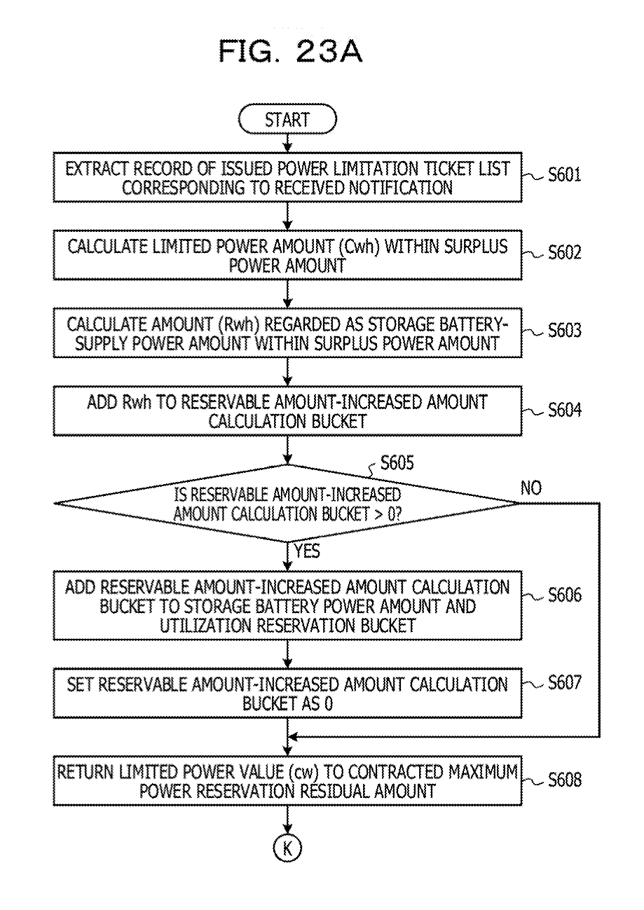

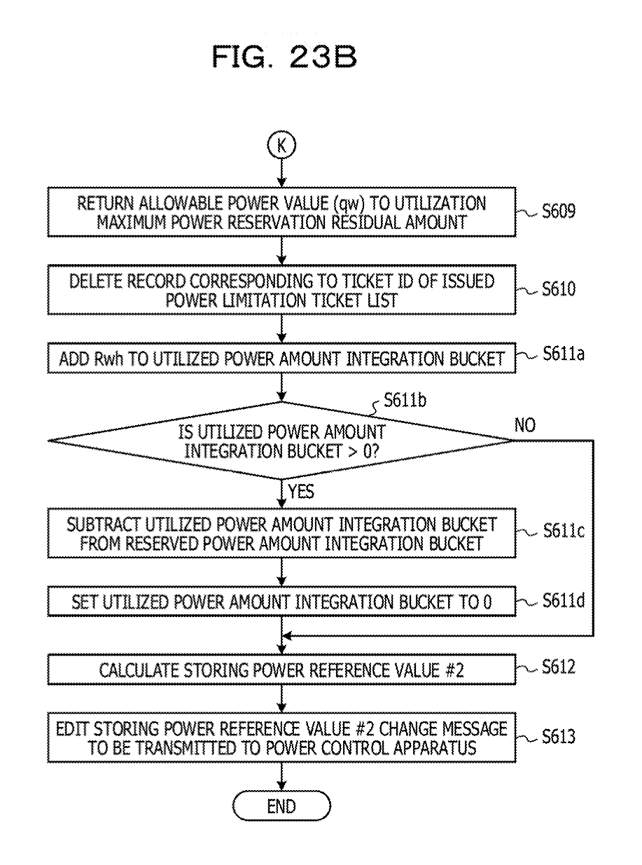

FIGS. 23A and 23B are flowcharts illustrating an example of a process when the power management apparatus of Embodiment 2 receives a power utilization end notification from the power consumption apparatus. When compared to the process illustrated in FIG. 14 of Embodiment 1, a process illustrated in FIG. 23B is different from the process illustrated in FIG. 14 in that Steps S611a to S611d are performed instead of Step S611. In the following, description will be made on processing different from Embodiment 1 in the process illustrated in FIG. 23B.

The control unit 31 adds the amount (Rwh) regarded as storage battery-supply power amount within the surplus power amount to the utilized power amount integration bucket (Step S611a). The control unit 31 determines whether the utilized power amount integration bucket >0 is satisfied (Step S611b). In a case where the utilized power amount integration bucket >0 is satisfied (YES in Step S611b), the control unit 31 subtracts an amount indicated by the utilized power amount integration bucket from the reserved power amount integration bucket (Step S611c), and sets the utilized power amount integration bucket as 0 (Step S611d).

The power management apparatus 3 of Embodiment 2 updates the reserved power amount integration bucket using an amount regarded as the storage battery supply power within the surplus power amount in the process when the power utilization end notification is received and thus, may suitably update the storing power reference value #2.

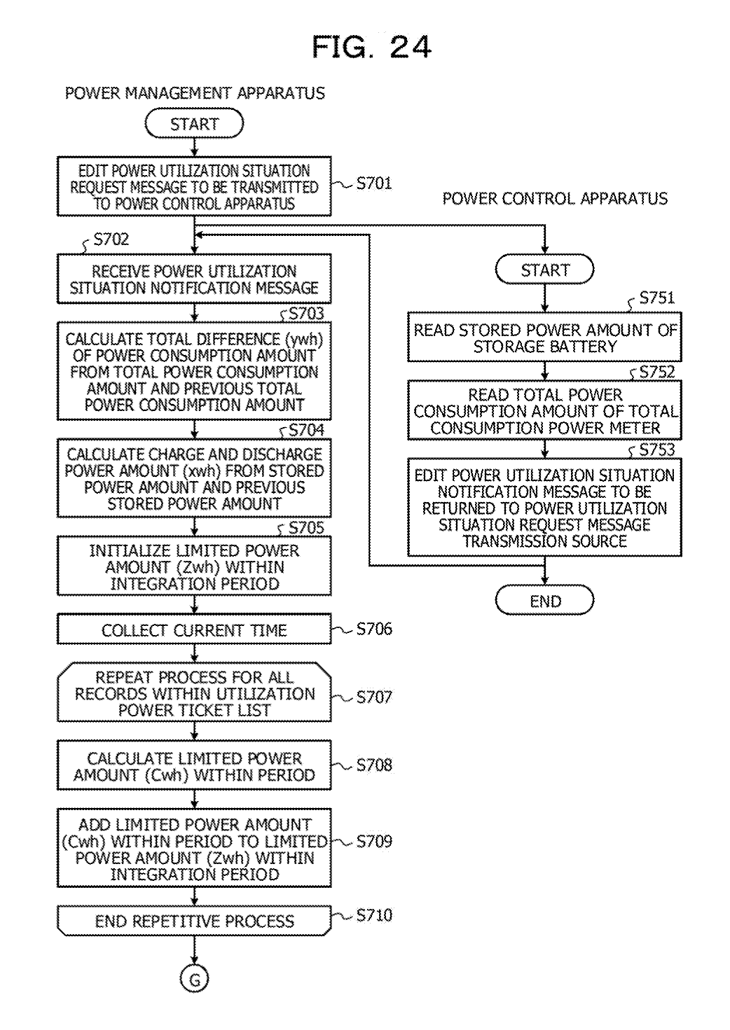

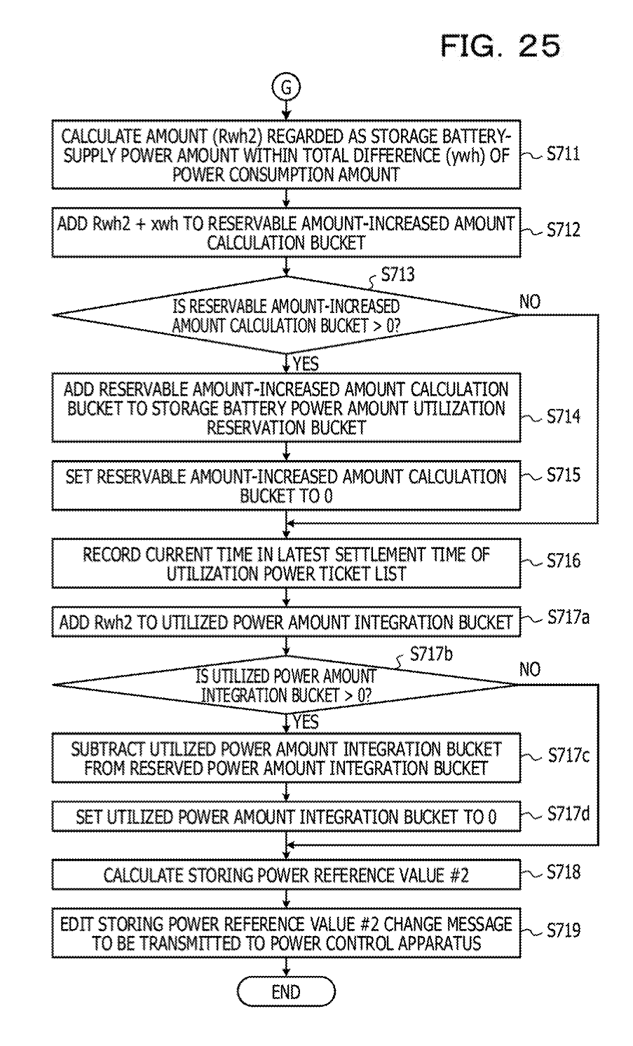

FIGS. 24 and 25 are flowcharts illustrating a process periodically performed by the power management apparatus and the power control apparatus of Embodiment 2. When compared to the process illustrated in FIGS. 15 and 16 of Embodiment 1, the process illustrated in FIGS. 24 and 25 is different from the process illustrated in FIGS. 15 and 16 in that Steps S717a to S717d are performed instead of Step S717. In the following, description will be made on processing different from Embodiment 1 in the process illustrated in FIGS. 24 and 25.

The control unit 31 adds the amount regarded as storage battery-supply power amount Rwh2 within the total difference (ywh) of power consumption amount to the utilized power amount integration bucket (Step S717a). The control unit 31 determines whether the utilized power amount integration bucket >0 is satisfied (Step S717b). In a case where the utilized power amount integration bucket >0 is satisfied (YES in Step S717b), the control unit 31 subtracts the utilized power amount integration bucket from the reserved power amount integration bucket (Step S717c), and sets the utilized power amount integration bucket as 0 (Step S717d).

The power management apparatus 3 of Embodiment 2 periodically updates the reserved power amount integration bucket using the amount regarded as storage battery-supply power amount (Rwh2) within the total difference (ywh) of power consumption amount and thus, may suitably update the storing power reference value #2.

Next, an example in which respective values described in the processes described above are represented by calculation formulas will be described. ₄T is the storage battery power amount utilization reservation bucket, ₅T is the reserved power amount integration bucket, ₂Tᵢ is the utilization residue power amount of the power consumption apparatus 2ᵢ, Yᵢ is the allowable power amount (reservation value) of the power consumption apparatus 2ᵢ, and ₄tᵢ is the storage battery reserved power amount to the power consumption apparatus 2ᵢ. Cᵢ(t) is the limited power value (reservation value) of the power consumption apparatus 2ᵢ, yᵢ(t) is a used power value (actual results) of the power consumption apparatus 2ᵢ, y(t) is the total power consumption amount, x(t) is the charge and discharge power value (becomes positive in charging), X is the stored power amount (actual results), and X₀ is the stored power amount (initial value).

The stored power amount X is represented as in the following formula (2-1).

X=X₀+∫x(t)dt (2-1)

The total power consumption amount y(t) is represented as in the following formula (2-2).

y(t)=Σyᵢ(t) (2-2)

The utilization residue power amount ₂Tᵢ is represented as in the following formula (2-3).

₂Tᵢ=Yᵢ−∫yᵢ(t)dt (2-3)

The limited power amount (reservation value) Cᵢ is represented as in the following formula (2-4).

Cᵢ=∫cᵢ(t)dt (2-4)

The allowable power amount (reservation value) Yᵢ of the power consumption apparatus 2ᵢ is represented as in the following formula (2-5).

Yᵢ=₄tᵢ+Cᵢ (2-5)

The storage battery power amount utilization reservation bucket ₄T is represented as in the following formula (2-6).

$$\begin{matrix}{}_{4} T = {X}_{0} - \sum {}_{4}^{}{t}{}_{i}^{} + \int y ( t ) dt + \int X ( t ) dt - \sum \int {c}_{i} ( t ) dt \\ = {X}_{0} + \int x ( t ) dt - \sum ( {}_{4}^{}{t}{}_{i}^{} + {C}_{i} - \int {y}_{i} ( t ) dt ) + \sum ( {C}_{i} - \int {c}_{i} ( t ) dt ) \\ = X - \sum {}_{2}^{}{T}{}_{i}^{} + \sum ( {C}_{i} - \int {c}_{i} ( t ) dt )\end{matrix} \qquad ( 2 \text{-} 6 )$$

The reserved power amount integration bucket ₅T is represented as in the following formula (2-7).

$$\begin{matrix}{}_{5} T = \sum {}_{4}^{}{t}{}_{i}^{} - \int y ( t ) dt - \sum \int {c}_{i} ( t ) dt \\ = \sum ( {}_{4}^{}{t}{}_{i}^{} + {C}_{i} - \int {y}_{i} ( t ) dt ) - \sum ( {C}_{i} - \int {c}_{i} ( t ) dt ) \\ = \sum {}_{2}^{}{T}{}_{i}^{} - \sum ( {C}_{i} - \int {c}_{i} ( t ) dt )\end{matrix} \qquad ( 2 \text{-} 7 )$$

₄T+₅T is represented as in the following formula (2-8).

₄T+₅T=X (2-8)

<Example of Hardware Configuration of Power Control Apparatus and Power Management Apparatus>

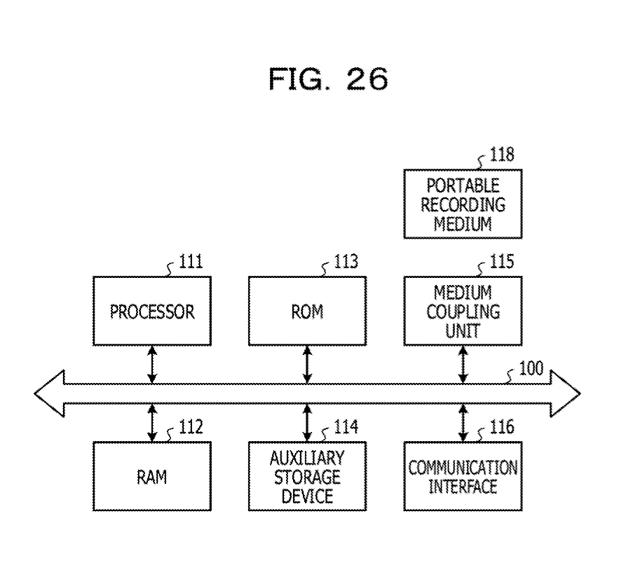

Next, an example of a hardware configuration of the power control apparatus 1 and the power management apparatus 3 in Embodiments 1 and 2 will be described with reference to an example of FIG. 26. As illustrated in the example of FIG. 26, a processor 111, a random access memory (RAM) 112, and a read only memory (ROM) 113 are coupled to the bus 100. Also, an auxiliary storage device 114, a medium coupling unit 115, and a communication interface 116 are coupled to the bus 100.

The processor 111 executes a program developed on the RAM 112. As a program to be executed, a power management program and a power control program that perform the processes in the embodiments may be applied.

The ROM 113 is a non-volatile storage device that stores the program developed on the RAM 112. The auxiliary storage device 114 is a storage device that stores various pieces of Information and for example, a hard disk drive and a semiconductor memory may be applied to the auxiliary storage device 114. The medium coupling unit 115 is installed to be capable of being coupled to the portable recording medium 118.

As the portable recording medium 118, a portable memory or optical disk (for example, a compact disc (CD), a digital versatile disc (DVD), and a semiconductor memory) may be applied. The power management program and the power control program that perform the processes of the embodiments may be recorded in the portable recording medium 118.

The storage unit 12 and the storage unit 32 may be realized by the RAM 112, the auxiliary storage device 114 and the like. The communication unit 13 may be realized by the communication interface 116. The control unit 11 and the control unit 31 may be realized by causing the processor 111 to execute a given power management program and power control program.

All of the RAM 112, the ROM 113, the auxiliary storage device 114, and the portable recording medium 118 are examples of a tangible and computer readable storage medium, and the tangible storage medium is not a transitory medium such as a carrier signal.

<Others>

The embodiment according to the present disclosure is not limited to the embodiments described above and various configurations or embodiments may be defined within a range without departing from a gist of the embodiment according to the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power management apparatus configured to control charge and discharge of the battery, power discharged from the battery being supplied to a power consumption apparatus, the power management apparatus comprising:
a memory; and
a processor coupled to the memory and configured to:
receive, from the power consumption apparatus, first information indicating a first power amount which is predicted to be used in the power consumption apparatus,
determine, based on the first power amount, a first value that is a value regarding a residual amount of the battery and is used for determining which of the charge and the discharge of the battery is to be preferentially executed, and
control, based on the determined first value and the residual amount of the battery, the charge and the discharge of the battery.

2. The power management apparatus according to claim 1, wherein the processor is configured to:
control the battery so that the discharge of the battery is executed more preferentially than the charge of the battery when the residual amount of the battery is equal to or greater than the first value.

3. The power management apparatus according to claim 2, wherein the processor is configured to:
determine the first value so that the first value is increased when the first power amount is increased.

4. The power management apparatus according to claim 3, wherein the processor is configured to:
control the battery so that the charge of the battery is executed more preferentially than the discharge of the battery when the residual amount of the battery is equal to or less than a second value smaller than the first value.

5. The power management apparatus according to claim 4, wherein the processor is configured to:
make a reservation, based on the first information, of supplying first power from at least one of a first power supply and the battery to the power consumption apparatus.

6. The power management apparatus according to claim 4, wherein the processor is configured to:
determine the first value based on a second power amount available to the power consumption apparatus.

7. The power management apparatus according to claim 5, wherein the processor is configured to:
determine the first value based on the first power amount when the reservation of supplying the first power from the battery to the power consumption apparatus is made.

8. The power management apparatus according to claim 4, wherein the processor is configured to:
acquire second information indicating a third power amount consumed by the power consumption apparatus, and
determine the first value based on the third power amount.

9. The power management apparatus according to claim 8, wherein the processor is configured to:
determine the first value based on a value obtained by subtracting a fourth power amount from the third power amount, wherein
the fourth value is predicted to be supplied from the first power supply to the power consumption apparatus.

10. The power management apparatus according to claim 8, wherein the processor is configured to:
acquire third information indicating a fifth power amount which is charged to the battery or discharged from the battery, and
determine a sixth power amount dischargeable from the battery, based on a value obtained by subtracting the fourth power amount from the third power amount, and the fifth power amount.

11. The power management apparatus according to claim 5, wherein the processor is configured to:
receive second power from a second power supply, and
supply at least a portion of the second power received from the second power supply to the first power supply.

12. The power management apparatus according to claim 5, wherein
the first information includes fourth information indicating an operation of the power consumption apparatus when the first power supply is failed, and
the processor is configured to:
determine an operation of the power consumption apparatus based on the fourth information when the first power supply is failed, and
instruct the power consumption apparatus to stop when the determined operation is a stop operation of the power consumption apparatus.

13. The power management apparatus according to claim 12, wherein
a plurality of the power consumption apparatuses are present, and
the processor is configured to:
set at least one of the plurality of power consumption apparatuses, of which the operation in a case where the first power supply is failed is the stop operation, as a group, and
instruct the power consumption apparatus belonging to the group to stop when the first power supply is failed.

14. The power management apparatus according to claim 8, wherein the processor is configured to:
receive, from the power consumption apparatus, fifth information indicating a seventh power amount which is obtained by subtracting the third power amount from the first power amount, and
determine a ninth power amount capable of being supplied from the battery, based on an eighth power amount supplied from the battery, among the seventh power amount.

15. The power management apparatus according to claim 8, wherein the processor is configured to:
receive, from the power consumption apparatus, fifth information indicating seventh power amount obtained by subtracting the third power amount from the first power amount, and
determine the first value based on the seventh power amount.

16. The power management apparatus according to claim 8, wherein the processor is configured to:
receive, from the power consumption apparatus, fifth information indicating seventh power amount obtained by subtracting the third power amount from the first power amount, and
determine the first value based on the eighth power amount supplied from the battery, among the seventh power amount.

17. The power management apparatus according to claim 5, wherein the processor is configured to:
make the reservation preferentially with respect to the battery in a case where the first information includes an operation guarantee request when the first power supply is in a power failure state.

18. The power management apparatus according to claim 11, wherein
the second power supply is a solar power generation apparatus.

19. A power management system comprising:
a battery; and
a power management apparatus configured to control charge and discharge of the battery, wherein
power discharged from the battery is supplied to a power consumption apparatus, and
the power management apparatus includes:
a memory; and
a processor coupled to the memory and configured to:
receive, from the power consumption apparatus, first information indicating a first power amount which is predicted to be used in the power consumption apparatus,
determine, based on the first power amount, a first value that is a value regarding a residual amount of the battery and is used for determining which of the charge and the discharge of the battery is to be preferentially executed, and
control, based on the determined first value and the residual amount of the battery, the charge and the discharge of the battery.

20. A power management method executed by a power management apparatus configured to control charge and discharge of a battery, power discharged from the battery being supplied to a power consumption apparatus the method comprising:
receiving, from the power consumption apparatus, first information indicating a first power amount which is predicted to be used in the power consumption apparatus;
determining, based on the first power amount, a first value that is a value regarding a residual amount of the battery and is used for determining which of the charge and the discharge of the battery is to be preferentially executed; and
controlling, based on the determined first value and the residual amount of the battery, the charge and the discharge of the battery.
